(19) United States
(12) Patent Application Publication
(10) Pub. No.: US 2005/0095569 A1
(43) Pub. Date: May 5, 2005

(54) Integrated multi-tiered simulation, mentoring and collaboration E-learning platform and its software

(76) Inventor: Patricia Franklin, San Francisco, CA (US)

Correspondence Address: VIERRA MAGEN MARCUS HARMON & DENIRO LLP, 685 MARKET STREET, SUITE 540, SAN FRANCISCO, CA, 94105, US

(21) Appl. No.: 10/697,602

(22) Filed: Oct. 29, 2003

(51) Int. Cl. G09B 3/00

(52) U.S. Cl. 434/350; 434/362

(57) ABSTRACT

A multi-tiered e-learning software platform and its software is disclosed including educational simulations, real-time and stored mentoring based on simulation performance and peer collaboration using the skill sets learned in the simulations and mentoring sessions.

### BACKGROUND OF THE INVENTION

1. Field of the Invention

The present invention relates to an e-learning software platform, and in particular to an e-learning software platform including educational simulations, real-time and stored mentoring based on simulation performance and peer collaboration using the skill sets learned in the simulations and mentoring sessions.

2. Description of the Related Art

Technological and economic factors are bringing about a change in business and educational paradigms in the United States and worldwide. Over the past few decades, corporate focus has transitioned from physical assets and production to intellectual capital and knowledge management. This intellectual capital is largely held in a company's employees. To maximize the value of this resource, companies are investing large sums of money in e-learning software directed at information dissemination to and between employees and which ensure that employees are up to date with changing business landscapes and practices. According to global market analyst IDC, worldwide revenues from e-learning markets will exceed $23billion by 2004. This in comparison to less than $2billion in 1999.

E-learning is generally defined as the CDROM-based or network-based use of multimedia technologies and the Internet to educate, train and disseminate information. An advantage of e-learning over traditional educational platforms is the ability to easily reach very large numbers of individuals. Moreover, e-learning does not require the educator and learner to come together at a particular time in a particular place. Rather, the educator may develop and deploy the e-learning software, and then the learner may use the e-learning software generally at a time and at a place convenient to the learner.

Despite the fact that E-learning has been touted as fundamentally changing teaching methods and models, e-learning software still tends to be linear progressions through a series of web pages or PowerPoint presentations, with limited or no interactivity. While some software offers synchronous training in real time, this software is conventionally done with a live instructor via Internet web sites or through audio- or video-conferencing. The learners log in at a set time and can communicate directly with the instructor and with each other. While this form of synchronous e-learning offers some advantages over a traditional classroom setting, it still requires the learners to be present at particular times.

A further disadvantage to conventional e-learning software is that it tends to be a somewhat dry transfer of the information content. Even if the overall topic is of interest to the learner, if the software is not set up in such a way as to retain the learner's interest or give a context to the information being taught, the learner can lose concentration and retain little of the information being disseminated.

### SUMMARY OF THE INVENTION

It is therefore an advantage of the present invention to provide a multi-tiered e-learning platform and its software that provides a user with education, training, mentoring and collaboration capabilities.

It is another advantage of the present invention to provide both synchronous and asynchronous e-learning which may be used at any time and any place by a user.

It is another advantage of the present invention to create an interactive simulation through which the information content is disseminated, thereby creating a memorable, life-like context for the information resulting in high retention of the information content.

It is a still further advantage of the present invention to provide an e-learning platform and its software that gives instant feedback and mentoring to a user based on a user's performance in a simulation.

It is another advantage of the present invention to provide an e-learning platform and its software where the feedback and mentoring may be from a wide variety of informational resources, including synchronous interaction with peers and asynchronous delivery of stored information.

It is further an advantage of the present invention to harness the knowledge and experience of a company's skilled employees, its databases and the knowledge of the Internet and make it available to users of the e-learning platform and its software.

It is another advantage of the present invention to allow a user to apply the skills learned in the simulation through collaboration between the user and others within or outside of a company or organization.

It is a still further advantage of the present invention to make the e-learning platform and its software interesting and fun to use through role-playing and the acquisition of gifts and rewards as the user progresses through the e-learning platform and its simulation software.

It is another advantage of the present invention to provide individual and constant recognition and acknowledgement for members of an organization, based on proficiencies and distinctions important to the organization, resulting in improved organizational development and retention of talent.

It is a still further advantage of the present invention that the e-learning platform and its software can be applied to the mastery of all content for which simulations, mentoring and/or collaboration may be applied.

It is another advantage of the present invention to provide personalized learning through the calibration of media assets per learner need according to data provided or gathered through assessment that has direct bearing on output of simulation, mentoring and collaboration assets.

These and other advantages are provided by the present invention which in embodiments relates to a multi-tiered e-learning software platform and its software including educational simulations, real-time and stored mentoring based on simulation performance and peer collaboration using the skill sets learned in the simulations and mentoring sessions. The platform and its software initially present the user with a self-assessment. The assessment is used by the e-learning platform and its software to tailor the simulation to one that most suits the skills of the user to be tested and developed. The user is then presented with one or more Instrumentals/Options screens, which graphically illustrate to the user the competency to be developed and the MetaMentors that will assist and mentor the user during the simulation. Both the competency and MetaMentors chosen are based on the user's self-assessment. The Instrumentals/Options screen next introduces the user to the characters with whom the user will interact within the simulation. The characters may be selected based on the user's self-assessment and/or the personalities of the people with whom the user interacts with in real life.

The platform and its software then introduce the first tier simulation. The first tier of the software platform presents the user with a simulation designed to test certain skill sets of the user and to provide mentoring and feedback in the areas where the simulation shows the user to need assistance. The simulation is presented via computer to the user in a series of learning assets comprised of scenarios that derive from interactive decision screens. The scenarios are comprised of a series of scenes depicting one or more characters or items- appropriate for the learning objective. The scenes are formed of one or more frames, and the frames are in turn comprised of a plurality of different granular reusable assets which have been tagged according to -values and classifications. These tags comprise metadata that contribute to the determination of the use and sequence of the assets within the frames. These assets, aggregated within frames, may be photographs taken of a variety of different people and of a variety of different body parts of those people. A number of such assets, together with an audio clip, text and, on occasion, animation, are called up from data repositories and aggregated into a frame, based on learning objectives and interactive decisions calling metadata that determine appearance, speech, attitude, mood, etc. of the character to be conveyed to the user in that frame. There is aggregation and tagging at each level: a) learning objective b) scenario c) scene d) frame e) asset for storage and reuse.

The invention delivers simulations of critical business situations. Users can practice various skills in a simulated, safe environment, shielded from the negative consequences of “incorrect” decisions in the real world. Advanced simulation and graphics technology, practiced for example in the computer game industry, is used to create a compelling and high-speed, interactive setting for the learner.

The user assumes the role of one of the characters in the simulation and is presented with situations in which the user is asked to select a course of action the user believes will result in the best outcome for the role-played character. The user is provided with feedback and mentoring regarding the selected course of action. In this way, the simulation measures and builds the user's skills, while at the same time giving a life-like simulated context to the skills learned so that they may be remembered and applied in the future.

The software platform and its software further provides MetaMentors to assist users. MetaMentors are stored objects representing famous people from the past or present. Each MetaMentor object also has associated stored knowledge, experience and information which is shared with users to teach, guide and reward users as they progress through simulation. Examples of MetaMentors may include Genghis Khan, Gandhi, Albert Einstein, Jane Goodall, Pablo Picasso and a variety of other famous people known to exemplify and illustrate skills and traits to be reinforced and taught by the software platform and its software. During use of the software platform and its software, the MetaMentors appear periodically or can be summoned to teach the user.

In conjunction with the tier one simulation, the present invention provides the user with the ability to obtain peer mentoring and collaborate with colleagues in a second tier virtual world available to the user 24 hours a day, 7 days a week. In the second tier, a user is able to receive mentoring and advice from various informational resources in relation to the situations presented in the simulation. These informational resources may be synchronous interaction with peers over the network, or they may be asynchronous delivery of relevant stored information over the network. The second tier also allows the user to collaborate with others over the network using the skills learned in the simulation.

### BRIEF DESCRIPTION OF THE DRAWINGS

The invention will now be described with reference to the drawings in which:

FIG. 1 is a schematic view of a system for supporting the software platform and its software according to the present invention;

FIG. 2 is a schematic view of the software according to the present invention;

FIG. 3 is a schematic view of the contents of the Sim Content database of the software according to the present invention;

FIG. 4 is a view of a multimedia graphics file of an Instrumentals/Options screen including competencies and MetaMentors according to the present invention;

FIG. 5 is a view of a multimedia graphics file of an Instrumentals/Options screen including the competencies and MetaMentors selected for the simulation according to the present invention;

FIG. 6 is a view of a multimedia graphics file of an Instrumentals/Options screen including various background colors and descriptors according to the present invention;

FIG. 7 is a view of a multimedia graphics file of an Instrumentals/Options screen including various media assets illustrative of a particular descriptor according to the present invention;

FIG. 8 is a view of a multimedia graphics file of a frame formed with media assets illustrative of a particular descriptor according to the present invention;

FIG. 9 is a view of a multimedia graphics file of an Instrumentals/Options screen including various characters from the simulation and their personality assessment according to the present invention;

FIG. 10 is a view of a multimedia graphics file of an island presented over the output device to the user while running the software platform and its software according to the present invention;

FIG. 11 is a view of a multimedia graphics file of an island and a MetaMentor presented over the output device to the user while running the software platform and its software according to the present invention;

FIGS. 12-25 are views of tier one multimedia frames, each including assembled learning assets, a text box and a graphical user interface presented over the output device to the user while running the software platform and its software according to the present invention;

FIG. 26 is a view of a Tier Two graphical user interface presented over the output device to the user while running the software platform and its software according to the present invention;

FIGS. 27-30 are views of multimedia graphics files showing various Avatar archetypes presented over the output device to the user while running the software platform and its software according to the present invention;

FIG. 31 is a view of a multimedia graphics file showing a virtual world and the Avatars and bots therein presented over the output device to the user while running the software platform and its software according to the present invention; and

FIG. 32 is a schematic view of a symbolic representation of the software platform and software according to the present invention.

### DETAILED DESCRIPTION

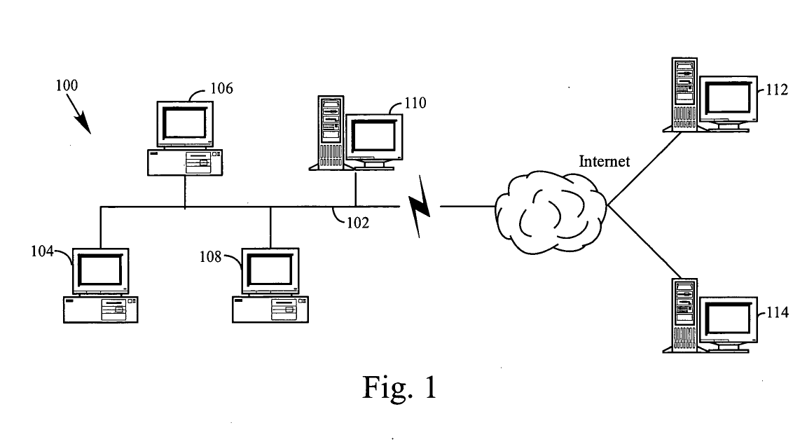

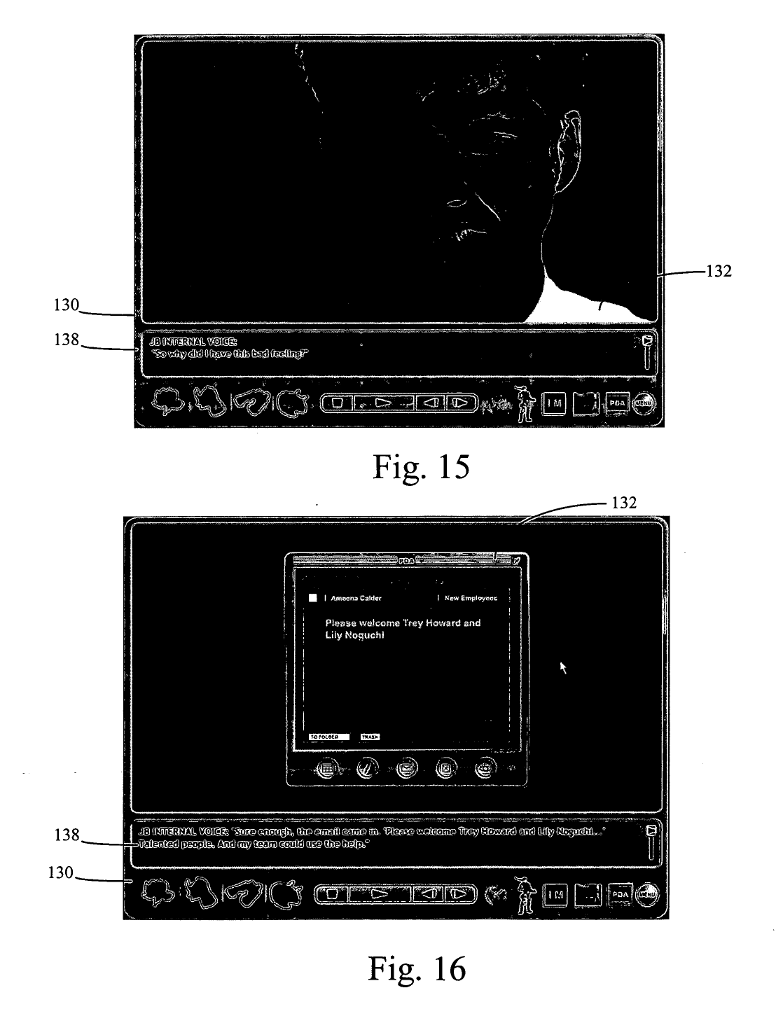

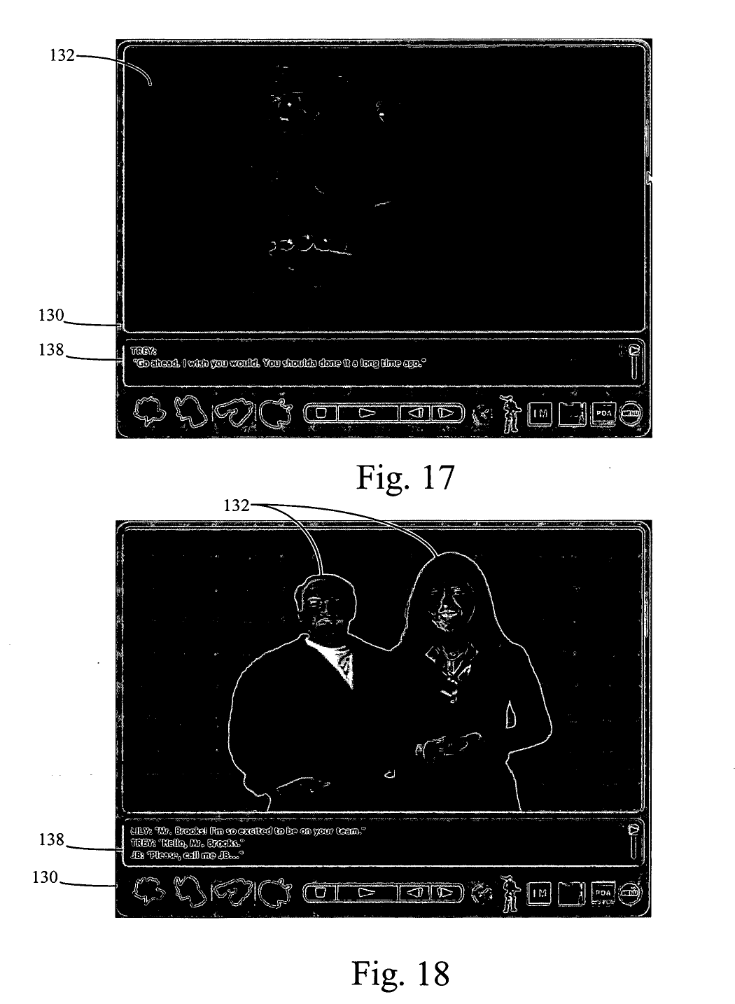

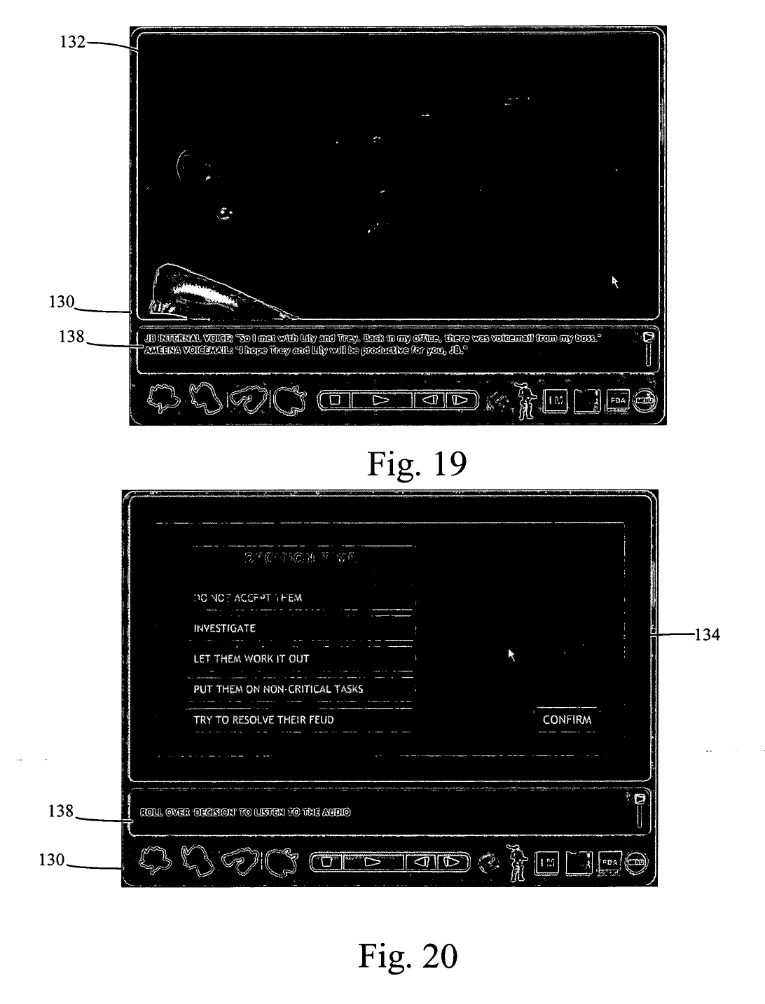

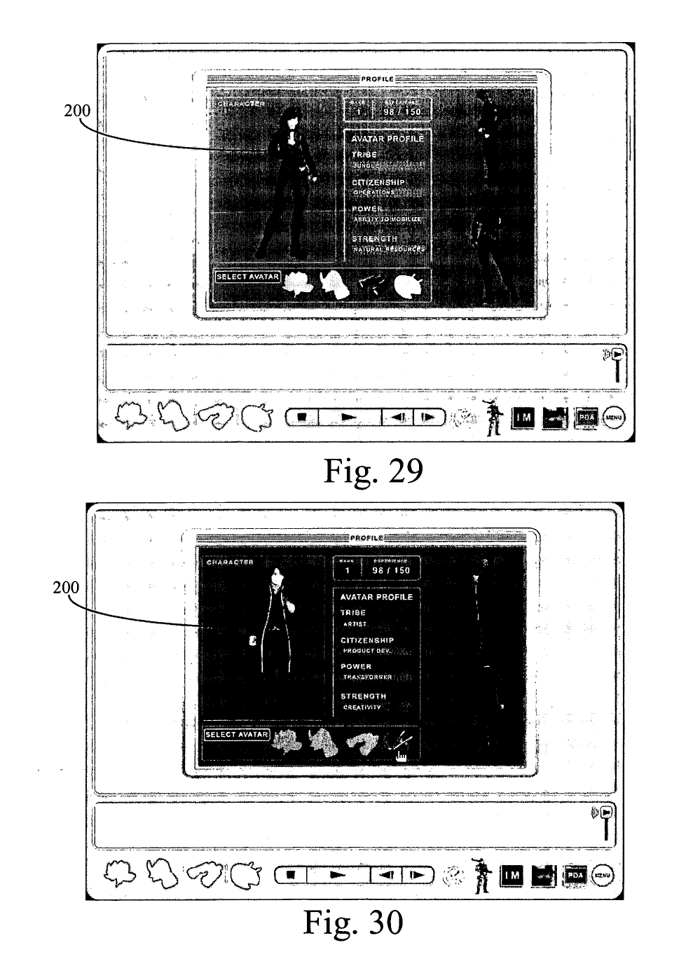

The present invention will now be described with reference to FIGS. 1-32 in which embodiments of the invention are shown. The present invention may, however, be embodied in many different forms and should not be construed as being limited to the embodiments set forth herein; rather these embodiments are provided so that this disclosure will be thorough and complete and will fully convey the invention to those skilled in the art. Indeed, the invention is intended to cover alternatives, modifications and equivalents of these embodiments, which will be included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details. In other instances, well known methods, procedures and components have not been described in detail as not to unnecessarily obscure aspects of the present invention.

Referring now to FIG. 1, there is shown a schematic view of a platform for supporting the software according to the present invention. The software operates on a computer system 100 connected to a network 102. The computer system may be a single computer 104, or multiple computers 104 through 108 networked together. Computer system 100 may include additional computers in alternative embodiments. A computer in computer system 100 preferably includes one or more processors, memory, a disk drive, input devices (such as a mouse and keyboard), output devices (such as a display and speakers), and a network interface (such as an Ethernet card, a wireless connection, a modem or a router). It is understood that computer system 100 may be a desk top computer, a lap top computer, or a hand-held computing device including a personal digital assistant or a mobile communications device.

Network 102 as shown includes a local area network (LAN) connected to the Internet. However, network 102 may be a LAN, a wide area network (WAN), a virtual private network (VPN), an intranet or the Internet. As explained in greater detail hereinafter, the software according to the present invention may connect to one or more local servers 110 or remote servers 112, 114 via the Internet. While one local server 110 and two remote servers 112, 114 are shown, it is understood that the software according to the present invention may link to any number of local and remote servers.

The software generated by the e-learning platform and its software according to the present invention may be downloaded to the computer system disk drive and run from the computer system 100. Alternatively, the computer system 100 may access and run the software according to the present invention where the software is located remotely from the computer system. For example, the software may be resident on a CD-ROM or a remote server, and run from the computer system 100.

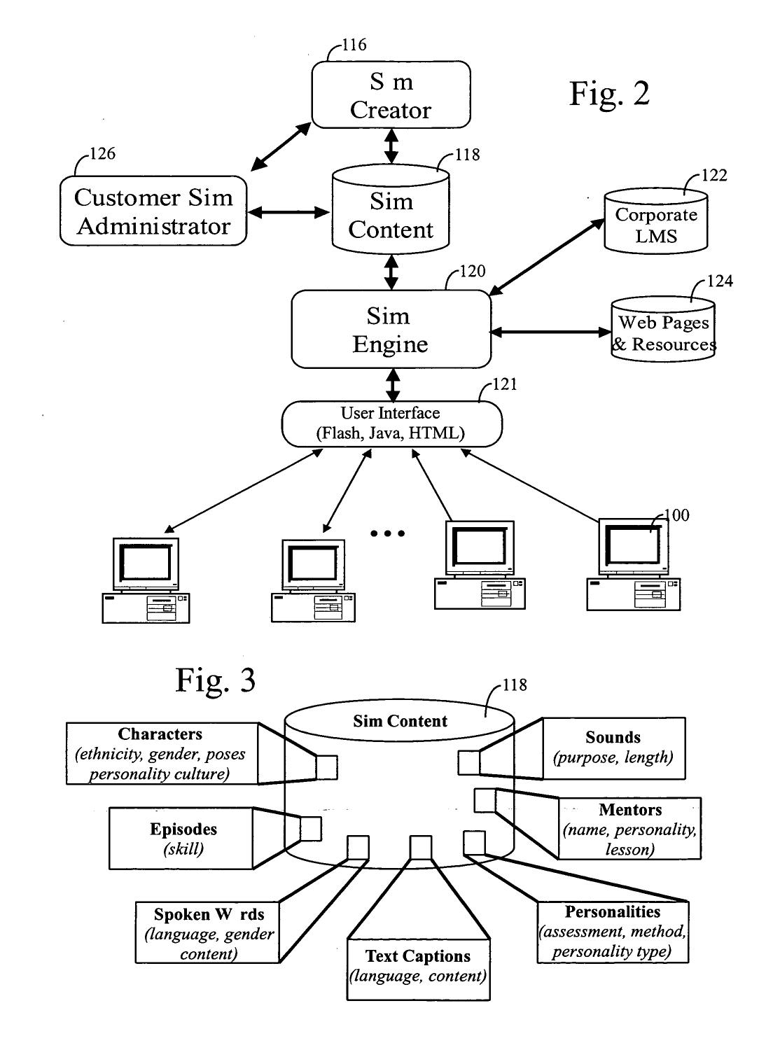

Referring now to FIG. 2, there is shown a schematic representation of the software according to the present invention. All simulation content is stored in a relational database repository 118. As explained hereinafter, simulations are constructed from learning objects and other data including media assets such as speech, text and sound stored in the relational database repository 118, and delivered dynamically to the user through a Sim Engine 120. The relational database repository can interface with Oracle, SQL Server, Sybase and any other database software using Java Database Connectivity (JDBC). The learning objects, media assets and other information may be assembled into simulation content from assets stored in the Sim Content repository and assembled by a Sim Creator module 116.

The Sim Engine 120 uses a standard 3-tier architecture and J2EE Java technology, developed by Sun Microsystems, Inc. of Mountain View, California, to implement the software according to the present invention. The J2EE platform uses Enterprise Java Beans (EJB) to deliver multimedia assets to the user, or several users simultaneously, over computer systems 100 via a user interface 121. As explained hereinafter, simulations are assembled from highly optimized content capable of rapid delivery to users. The Sim Engine supports links to customer information resources 124, including internal and external web pages, instant messaging chat sessions with subject matter experts, and other customer information systems.

A link to a legacy Learning Management Systems (LMS) 122 may be implemented in a Sim Administrator module 126. Simulations are often defined and accessed as learning objects and other data in LMS systems run by the organization. For customers without an LMS, the Sim Administrator module grants access to content by users and groups. Usage and tracking reports can also be generated.

Those of-skill in the art will appreciate that the following functional description of the software according to the present invention may be implemented in various other known programming languages and other multimedia platforms in alternative embodiments.

High Level Software Functionality

As explained in greater detail hereinafter, when run by a user, the e-learning software platform and its software according to the present invention initially calls stored multimedia files having graphics and audio contents which present introductory screen shots over the computer system output device(s). The software may also take and verify a user's logon and registration credentials at this time. The software may then call a multimedia file presenting an overview of the goals of the e-learning platform and its software.

The simulation is then introduced to the user by one or more animated images that describe a broad category of learning to be covered by the simulation, such as for example “Managing Change.” The user is then prompted with questions that take a self-assessment of the user. The assessment is used by the e-learning platform and its software to tailor the simulation to one that most addresses specific needs and suits the skills of the user to be tested and developed. Each answer to the questions presented in the self-assessment calibrates a diagnostic instrument graphically shown to the user, which arrives at a subset of the broader category of learning, for example, Conflict Resolution, based on the user's answers to the self-assessment. Data gathered about the user from the assessment also determines the subsets of broader categories of learning objects, scenarios, scenes, frames and media assets that will be deployed for the particular learner.

The user may then be presented with an Instrumentals/Options screen where the user is shown a wide variety of learning subsets, or competencies, under the broader category of learning, including the particular competency that was selected based on the user's self-assessment. The MetaMentors that will assist and mentor the user are also selected at this time. The MetaMentors are selected based on the user's self-assessment. The user is shown a further screen of background colors which will appear in the frames of the simulation. The background colors are selected to convey certain descriptors and learning modalities related to the specific competency of the subject simulation. The Instrumentals/Options screen next introduces the user to the characters that are to appear in the simulation. The characters are selected based on the user's self-assessment, and, possibly, on the personality assessments of those the user works or associates with.

After the assessment and the Instrumental/Options screens, the software initiates the first and second tier functions of the e-learning platform and its software. In the first tier, the user, following simulation character introductions, assumes the role of a character in a simulation and is presented with situations in which the user, in a series of decision points, is presented with a variety of actions from which to choose courses of action resulting in varieties of outcomes for the role-played character. The user is provided with feedback and mentoring regarding the selected course of action. In this way, the simulation measures and builds the user's skills, while at the same time giving a context to the skills learned so that they may be remembered and applied in the future. In the second tier, a user is able to receive mentoring and advice from various informational resources in relation to the situations presented in the simulation. These informational resources may be synchronous interaction with peers over the network, or they may be asynchronous delivery of relevant stored information over the network. The second tier also allows the user to collaborate with others over the network using the skills learned in the simulation.

Self-Assessment

The software according to the present invention presents the user with a series of questions for a self-assessment analysis for the purpose of determining the user's strengths and weaknesses. This might be in the form of a personality assessment or a skills-based assessment. A typical self-assessment analysis which may be employed by the present invention is the Myers Briggs Type Indicator test. Alternatively or additionally, the user may be given the Riso-Hudson Enneagram Type Indicator test. Both of these tests are among a large number of tests that the invention may use to calibrate meaningful simulations. Personality assessments, or instruments as they are often called are designed to reveal a user's personality traits, their idiosyncratic stressors and relaxers as well as the strengths and weakness of an individual with respect to dealing with other personality types. Personality assessments may also be taken of the user's coworkers and/or associates so that the coworkers/associates may be modeled in the simulation. This allows the user to deal with people in the simulation very much like those they deal with in real life. Certain situations can also be calibrated to provide high fidelity resonance with circumstances of various jobs and therefore may involve many other different kinds of assessments other than those concerned with personality assessment.

The assessments and instruments used to calibrate personalized simulations for each user rely on empirical data about the tendencies of the user, including their personality type or indications that the user lacks particular skills. In some circumstances, the assessments may also reveal certain tendencies of the user, such as for example, health related issues including the ability to lose weight and the ability to abstain from substance abuse. The information gained from the self-assessment test is stored in the computer system memory or disk drive for use in the simulation as explained hereinafter. Any previous self-assessment test taken by the user could be accessed and used to calibrate personalized simulations.

While embodiments of the present invention use the user's self-assessment to determine assets, frames, scenes, scenarios, learning objects and episodes as described hereinafter, it is understood that assessments other than self-assessments may be used in the place of the self-assessment in alternative embodiments.

Instrumentals/Options Screens

The user may then be presented with a number of Instrumentals/Options screens as shown in FIGS. 4-9. FIG. 4 is a representation of a stored media file where the user is shown a wide variety of learning subsets, or competencies 500, under the broader category of learning, including the particular competency (502) that was selected based on the user's self-assessment. This screen also presents a large number of potential MetaMentors 504 who will accompany and guide the user through the simulation. From this large number, a smaller number of MetaMentors 506 are selected, for example four, as the MetaMentors for the user's simulation. There may be more or less than four in alternative embodiments. These MetaMentors (described hereinafter) may be chosen based on several criteria in alternative embodiments. In one embodiment, the particular MetaMentors may be selected because they possess skills that are most likely to improve the user's behavior skills, as measured by the self-assessment. In particular, each potential MetaMentor has associated data relating to the MetaMentor's strengths, which comprises metadata that is categorized, or tagged. The MetaMentors that are selected in this embodiment are those whose metadata reveal that they will be the most helpful. In an alternative embodiment, MetaMentors may be selected because they are the ones whose tagged metadata reveals that they are most like the user. In this embodiment, at least one MetaMentor may also be chosen because his/her tagged metadata reveals that their personality is substantially different and potentially conflicting with that of the user's. This or these different MetaMentors may be chosen to challenge the user during the simulation. It is understood that in a further embodiment, a mix of MetaMentors may be selected from any of the above embodiments.

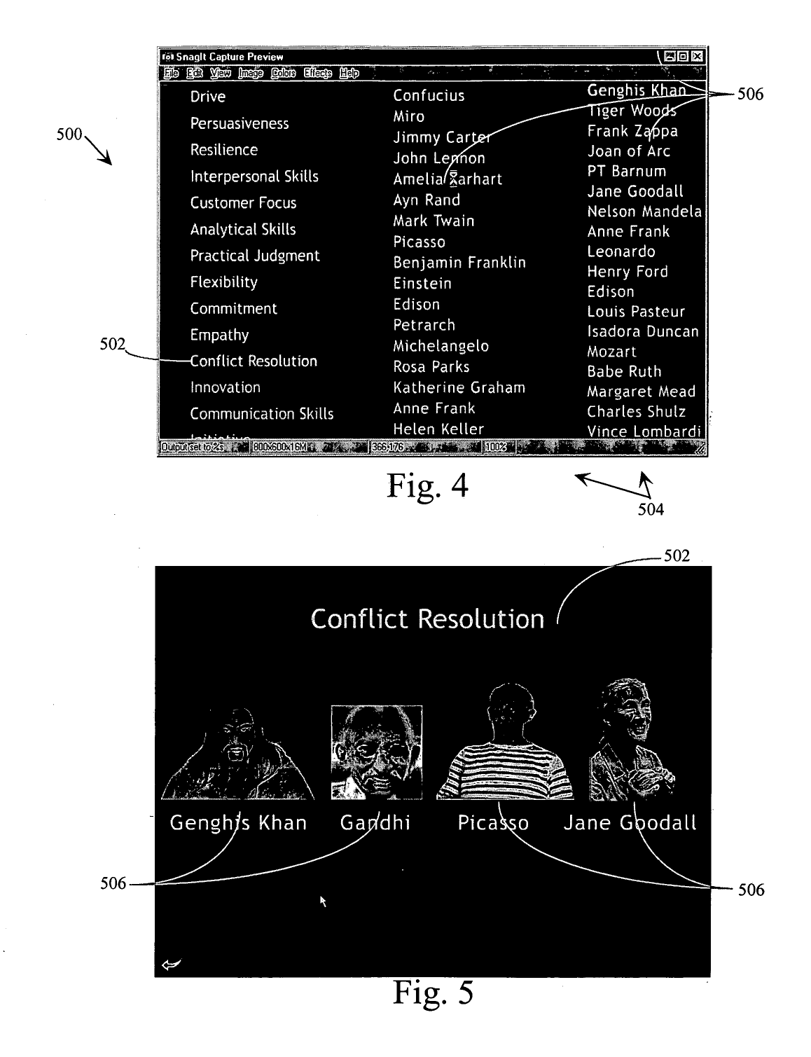

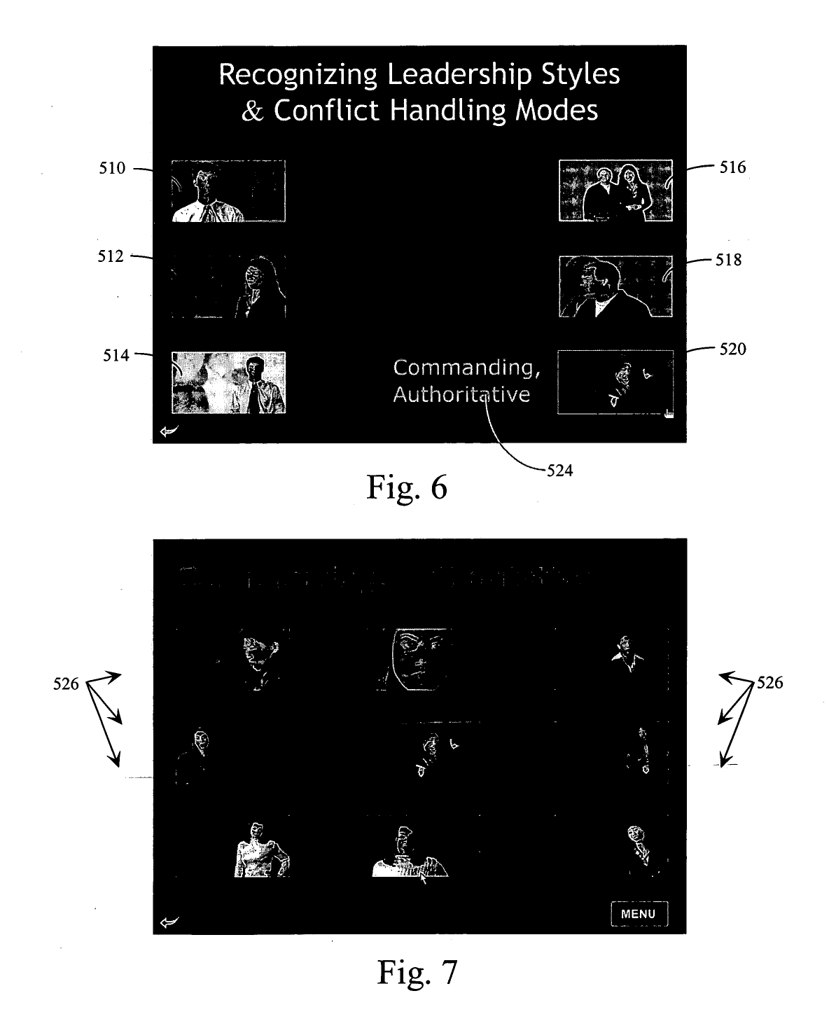

Once the competency and MetaMentors are selected and shown (for example as in FIG. 5), the user is next presented with a screen which introduces the concept of background color as a descriptor and learning modality as shown in FIG. 6. During the simulations, the frames (discussed hereinafter) will at least often have a background color which can be used to reveal information to the user about the simulated situation. These colors can stand for a wide variety of descriptors and learning modalities. As one example, in a simulation dealing with conflict resolution, there may be six different background colors 510 through 520, each representing a different descriptor for recognizing conflict and how to handle it (one descriptor 524 being shown in FIG. 6). In this example, the colors and descriptors may be as follows:

| | |
|---|---|
| Green | Affiliative, Avoiding |
| Blue | Coercive, Competing |
| White | Democratic, Compromising |
| Yellow | Collaborative, Accommodating; Coaching |
| Orange | Pace Setting, Driver |
| Red | Commanding, Authoritative |

These colors and descriptors are merely an example, and both the colors, and the type information described may vary in alternative embodiments. The different descriptors 524 are selected based on the result of the self-assessment as a method of facilitating the simulation and mentoring process. As shown in FIG. 6, a screen may be provided showing each of the colors with a picture exemplifying the descriptor. The descriptor may also be displayed next to the color, or may be visible when the color is accessed by the mouse pointer (as shown in FIG. 6).

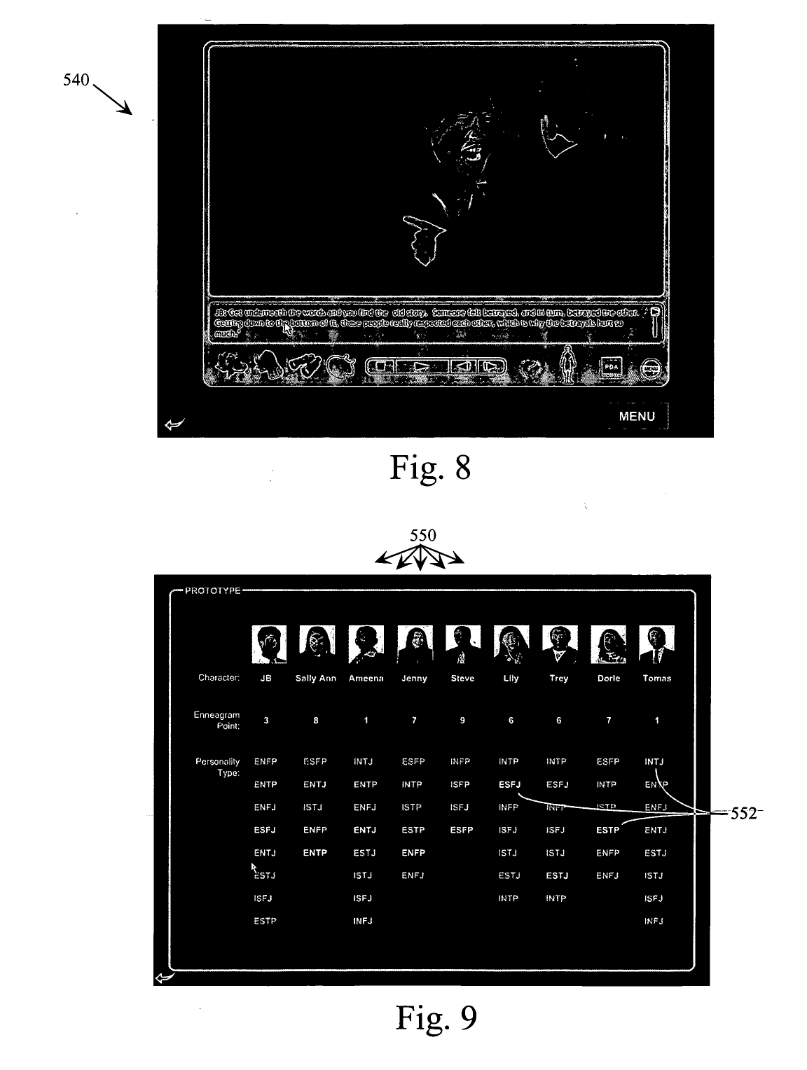

When a color is clicked on with a mouse pointer, a screen may be presented as shown in FIG. 7 illustrating different backgrounds and media assets 526 embodying the descriptor chosen. In FIG. 7, the descriptor is Commanding, Authoritative and the color is red. As such, a number of backgrounds and media assets from the simulation embodying this descriptor are shown. As a further possibility, if one of the backgrounds and media assets from FIG. 7 are accessed and clicked, the software may present a frame 540 from the simulation as shown in FIG. 8 illustrating how the accessed background and media assets may be used in a frame.

After the background colors and the descriptors for which they stand are presented to the user, the Instrumentals and Options screen next presents the user with the cast of characters 550 that will appear in the simulation, along with a personality assessment 552 of each character, for example as shown in FIG. 9. These characters are selected by the software based on the user's self-assessment, and, in embodiments, the personality assessments of the user's co-workers, supervisors and/or associates of the organizations. At the character introduction and selection screen, all of the icons of the graphical user interface, except for the MetaMentor gifts, become visible and can be activated. The graphical user interface is discussed in greater detail hereinafter.

E-Learning Platform and its Software Overview

After the self-assessment and Instrumental/Options screens, the platform and its software present the user with an overview of the goals and methods of the software. One or more multimedia files are called which present graphics, text and/or audio to the user presenting a user with objectives of the tier one simulation and the tier two peer mentoring and collaboration. These objectives include measuring and building interactive skills and knowledge base, as well as facilitating collaboration with others. The user is also told how to navigate around within the software platform and its software using the graphical user interface (GUI) presented to the user on the display screen.

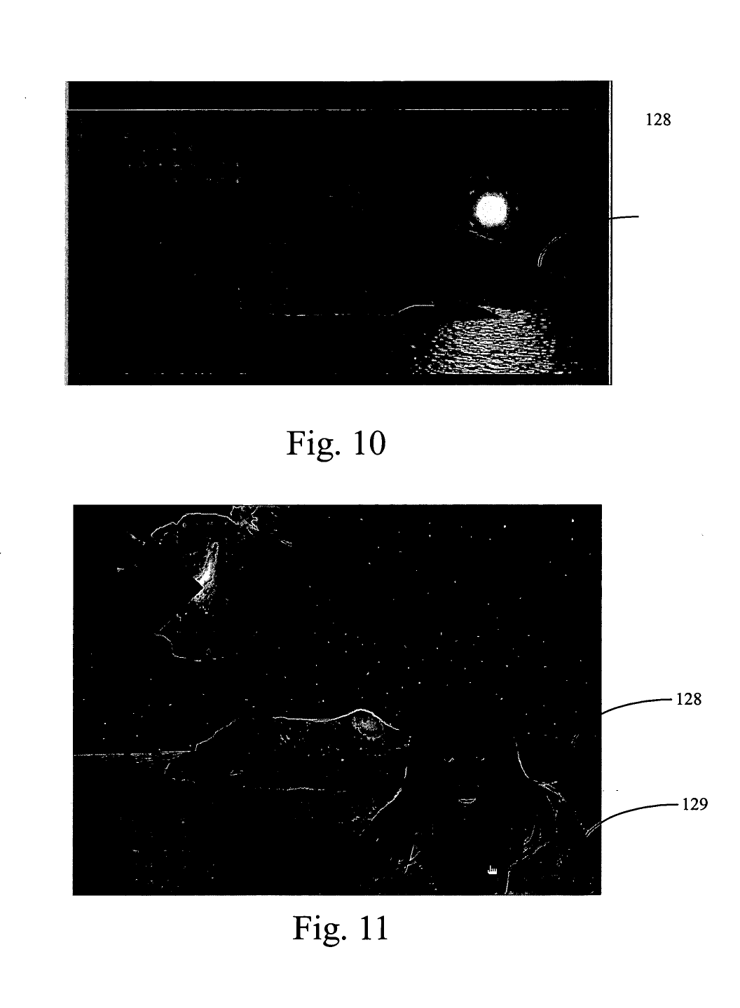

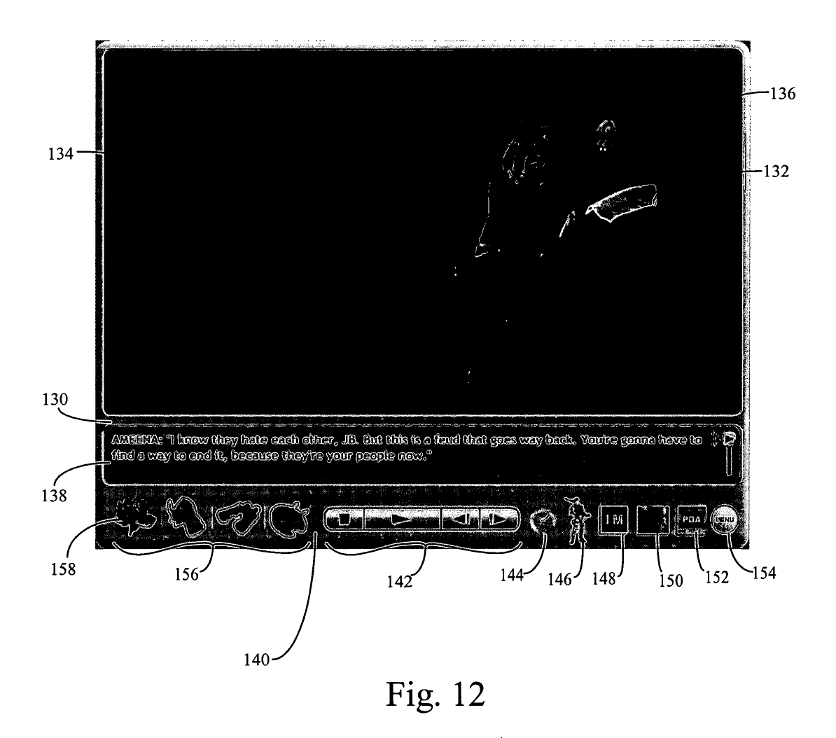

In one embodiment, the overview multimedia files may present an animation of an island, such as for example island 128 shown in FIG. 10. The overview may also introduce and be narrated by MetaMentors, such as for example MetaMentor 129 shown in FIG. 11. MetaMentors are stored objects representing famous people from the past or present. Each MetaMentor object also has associated stored knowledge, experience and information which is shared with users to teach, guide and reward users as they progress through a simulation. The MetaMentors may also appear as part of a multimedia file such as shown in FIG. 11. Examples of MetaMentors may include Genghis Khan (as shown in FIG. 11), Gandhi, Albert Einstein, Jane Goodall, Pablo Picasso and a variety of other famous people known to exemplify and illustrate traits to be reinforced and taught by the platform and its software. During use of the platform, and its software, the MetaMentors appear periodically or can be summoned to mentor and assist the user as explained hereinafter.

During the overview, each of the MetaMentors may be introduced to the user by calling multimedia files containing their images and narration about them. Additionally, hyperlinked images of each MetaMentor may be provided on the GUI, which, when accessed with the mouse pointing device, can call up a routine containing additional history and information about the accessed MetaMentor.

The overview may also introduce the concept of subject matter experts (SMEs), who are stored objects representing actual mid- to high-level employees and officers within as well as outside the company or organization. The knowledge that they possess is gained through real life skill and experiences working within and/or outside the company. This knowledge is documented and stored for use by others within the company. SMEs also may include experts external to the organization. Each SME may have a unique graphical representation that may appear to the user during use of the software platform and its software. When represented in Tier Two, SMEs are known as Bots: static representations of the expert or knowledge that can be clicked and whose data can be displayed in a variety of asynchronous, searchable media formats. By accessing an SME, the user may access the knowledge, skill and experience of that SME as a mentoring tool. The SMEs are also a data source whose assets can be updated by experts, organizations or the inventor.

The use of SMEs also have a purpose independent of their worth as mentors to users of the software platform and its software. The creation of an SME from a company or organization employee serves as a tool to reward good employees and to prevent good employees from leaving the company or organization. Namely, once an employee has been memorialized as an SME within the software platform's communal second tier according to the present invention, they are less likely to want to forfeit the recognition they gain from being an SME. Moreover, in the event an employee does leave, their knowledge is preserved in the software platform and its software. The embodiment of good employees as SMEs also provides for communities of best practice wherein the zones around them in Tier Two become magnet host environments for like-minded experts and interested people who participate in the zone's threaded chat discussions and become recognized for contributions to the community. Embodying good employees as SMEs also allows for strategic deployment of workforce (whose skills are now made more apparent) through reward systems geared to the values of an organization. The rewards may include the enhancement of a person's Avatar, which is their representative image (explained in greater detail hereinafter) in Tier Two. In this way, if an organization values teamwork, for example, each action made by a person—either through completion of a simulation on teamwork, a helpful act such as sharing of knowledge in a chat room, an introduction of an expert to a team member, an efficient method of networking to locate resources to achieve a work group objective, etc.—each action may have values and those values are depicted in meaningful appearances of the individual's Avatar. Thus, organization members may be rewarded such that, for example, a pauper image becomes prince-like or a weakling becomes an Olympian so that members of an organization can instantly appreciate who has achieved what status and why. Because such achievements may ordinarily not be noticed in large organizations except during staged peer-reviews, in this way the individual's achievements, driven by new levels of status and recognition will likely increase and the organization, easily aware of who has achieved what on a daily basis, can be more flexible in meeting the ever shifting demands of both market and competitive forces.

Tier One—The Simulation

The simulation in general uses dramatic scene sequencers as in non-linear computer games wherein classic scene structure (Act One: Set Up; Act Two: Dilemma; Act Three: Chaos; Act Four: Resolution) is broken up by menu choices that can change the course of the simulation through simulating the rewards and consequences of selected behavior options one experiences in life. These non-linear pathways are embedded in the classic scene, story and structure, and the software ultimately returns the player to this structure. In particular, a fact pattern is presented by the characters in a series of scenes, which are formed of individual frames, which are in turn formed of assets, audio clips, a text box and a user interface. A scene culminates in a scenario which is one of several courses of action represented in a learning object. From the user's perspective, the learning object is a decision point,where the user is provided with a number of possible scenarios and asked to select the scenario that will result in a good outcome for the character role-played by the user. The learning objects all together form a given episode, such as the conflict resolution competency described above. Various episodes may together form a series, such as the managing change theme discussed above.

The object of the simulation is to measure and build the user's skills, while at the same time giving a context to the skills learned so that they may be remembered and properly applied in the future. The software initially presents the user with a recorded sequence of multimedia graphics and sound files which portray the setting in which the simulation is to take place. In embodiments of the present invention, this setting may typically be a company in which the user is asked to role play one of the company employees, and asked to respond to situations presented by the simulation in such a way as to result in the best outcome for the company. However, it is understood that the software according the present invention may be used in any number of organizational settings, and the simulation adapted to that particular setting. For example, in addition to business settings, the organization for which the software may be adapted may include educational settings, governmental settings, healthcare settings, family or social settings and any number of other settings which would benefit from mentoring and collaboration skills. While the present invention is described hereinafter with respect to a business setting, the term “organization” used herein refers to each of these settings.

At the onset of the simulation, in embodiments of the invention, the history of a simulated company may be presented to the user over the computer system output device(s) from a stored multimedia file containing a series of simulated newspaper headlines. The newspaper headlines provide a simulated timeline of events culminating the present day status of the simulated organization. It is understood that an overview of the state of the simulated company or organization may be presented to the user in a wide variety of other formats, including by text alone, narration alone and video or animation clips.

The simulation is presented to the user through a series of multimedia frames that are called from storage and presented over the output devices. Each frame is comprised of a variety of components, including granular reusable assets (hereinafter referred to as “assets”). In embodiments of the invention, the assets may be photographs, taken individually or isolated from video clips, which, in one classification, may be broken down into two broad categories: foreground assets and background assets. The foreground assets are generally photographs of various people from head to toe or a partial body shot for example from the waist up. The background assets are generally photographs of close-up shots of body parts, for example eyes and hands, of the people shown in the photographs forming the foreground assets.

The photographs which form the background and foreground assets are taken of a wide variety of people, having diverse appearances and backgrounds. The people in the photographs may be different sexes, different ethnic backgrounds, different appearances, formal dress and casual dress, older and younger, larger, imposing appearance and smaller, non-threatening appearance, etc. The foreground assets are further taken with the people having a variety of different facial expressions, such as happy, sad, angry, etc. The background assets are taken of various body parts that convey emotion such as eyes, hands, etc.

Each of the foreground and background assets are given a set of descriptive data for system and user access and re-use. In particular, each learning object is tagged into one or more metadata categories. The metadata categories are classifications of the assets by appearance, purpose, goal and/or learning outcome. Each metadata category includes a number of subcategories.

One metadata category, discussed above, is comprised of two subcategories: foreground assets and background assets. A second metadata category is for different characters, and is comprised of a number of different subcategories, one subcategory for each character who may appear in the simulation. As indicated, there are several assets for each character, with all assets of a particular character being tagged into its own subcategory within this metadata category. A third metadata category is for demographic information, with several subcatagories, one each for assets of a particular sex, ethnicity and age. Thus, for example, a subcategory in this metadata category may include assets of different women. A fourth metadata category is for setting information, with several subcategories, one each for assets in a formal attire setting, a casual attire setting and a sports attire setting. A fifth metadata category is for emotional appearance, with several subcategories, one each for assets having a happy appearance, an angry appearance, a sad appearance, a surprised appearance, a concerned appearance and a confused appearance. A sixth metadata category is for personality type, with several subcategories, one each for each of the personality types given by one or more of the self assessment paradigms commonly used (for example the Myers Briggs Type Indicator test and/or the Riso-Hudson Enneagram Type Indicator test). As would be appreciated by those of skill in the art, there may be additional metadata categories for different appearance classifications of the assets, and additional subcategories within each of the above-described metadata categories.

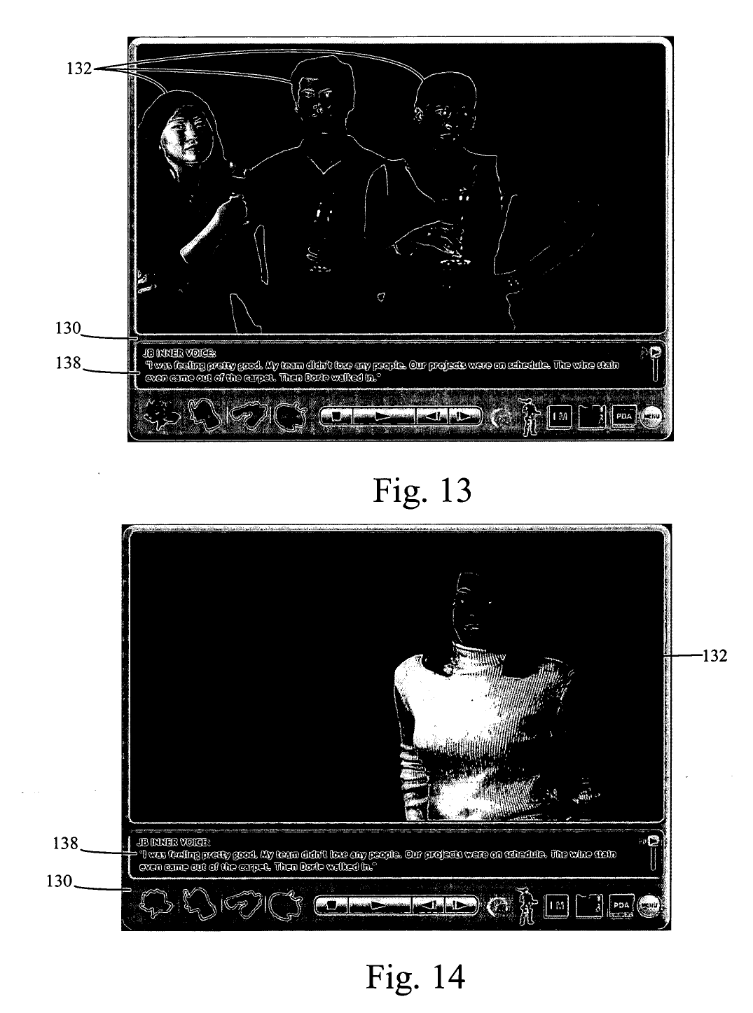

Each asset is tagged with one or more identifiers classifying that asset as belonging to a particular subcategory in one or more metadata categories. For example, FIG. 12 shows a frame 130 which may be presented during the simulation. The frame 130 includes a foreground asset 132 and a background asset 134. The foreground asset 132 is of a woman who may appear as a character in the simulation, her name may be Ameena although the name may be different in alternative embodiments. The foreground asset 132 belongs to one subcategory of a variety of different metadata categories. The foreground asset 132 may be tagged as belonging to the “Ameena” subcategory of the character metadata category. The foreground asset 132 may be tagged as belonging to the female subcategory of the gender metadata category. The foreground asset 132 may further be tagged as belonging to the formal attire subcategory of the setting metadata category. The foreground asset 132 may additionally be tagged as belonging to the angry subcategory of the emotion metadata category. In this way, the foreground asset 132 belongs to a subcategory in a variety of different metadata categories.

Referring still to. FIG. 12, the frame 130 is comprised of a variety of different assets. As indicated above, it may contain the foreground asset 132 and the background asset 134. It may further include a background color 136, in this instance red, to depict a particular behavior. In the embodiment shown in FIG. 12, the background color depicts a particular leadership style and conflict handling mode. The background color may represent a variety of other descriptors in alternative embodiments. As explained in greater detail below, a frame 130 may further include a text box 138 and a user interface 140.

Different foreground and background assets, colors, audio and text (explained hereinafter) are called up to create a frame. Which foreground and background assets, colors, audio and text are called is determined by the software engine 120 depending on the self assessment performed by the user, as well as the emotional state and appearance of the character to be depicted by the software to the user at that point in the simulation. For example, a user's self assessment may indicate that the user needs improvement in dealing with conflict and confrontational situations. The software of the simulation is primed to call up various assets, colors, audio and text into a series of frames triggered into display sequences by selections made by the user at various decision screens in which several choices are presented and selected. In the case of the described need for the user to gain mastery in handling conflict, the simulation provided by the platform and its software to the user may set up a simulated confrontation between two characters, with a variety of options of how the user may choose to deal with the confrontation. Each decision screen is regarded as a learning object and contains selectable options that take the user down interactive pathways that may hold rewards or penalties. These rewards or penalties are shown to the user in the form of scenarios comprised of scenes and frames. If the user reacts well to a given simulated situation (as described below), a series of frames may be assembled from assets, colors, audio and text, which, when taken together, present a happy outcome in which simulated colleagues show their approval or appreciation. As each of the assets, colors, audio and text are tagged, the software is able to pull together the appropriate objects to create the appropriate mood and/or appearance of the characters presented and to place those assets into mutable, pre-formed frames, scenes, scenarios and learning objects.

A number of frames may be strung together and presented successively to the user to create what is referred to herein as scenes. In embodiments of the invention, a typical scene may include one to four frames. In addition to the foreground and background assets and color, each character may have a number of recorded sound files for each frame or series of frames in which they appear. A variety of sound files are stored and tagged as described above so that each series of frames that comprise a scene that is presented to the user also has an associated sound file that is called when the frames of a scene are shown. In addition to words spoken by the character presented, the software may additionally have background music which further creates the appropriate mood to be portrayed in the scene. As indicated above, text box 138 may also be provided to have a visual display of the words being played by the audio clip.

The assets may be stored in a variety of known formats, such as for example gif, jpeg, tif and png, in directories and relational databases. Similarly, the audio may be stored in a variety of known formats such as for example wav and mp3 files and also stored in directories and relational databases. The graphics and audio files may be downloaded onto the computer system hard drive at the time the software is installed onto the computer system. Alternatively, the graphics and audio files may be loaded during the simulation directly from a remote location (CD ROM or website). The graphics and audio files, created using known multimedia software applications, such as PhotoShop, Illustrator, FreeHand, 3D Studio Max, SoundForge, Macromedia Flash®, etc. may be called up into simulation scenes using the technologies previously described. Embodiments of the invention use still images as assets that may be strung together to form the scenes. This type of multimedia uses much less bandwidth than would a video format. However, it is understood that a variety of other multimedia formats may be used, such as for example video and/or animation sequences.

A simulation may use all of the stored assets as characters in the simulation. Alternatively, a simulation may use only a subset of the assets, with the selected assets being determined based on the user's assessment. For example, if a personality assessment indicates that a user is less comfortable dealing with authority figures or powerful people, the software may heavily skew the selected assets to those including people with an imposing appearance or powerful personality.

At the beginning of the simulation, assets showing each of the different characters to be used in the simulation may be presented over the output device and introduced to the user. The user at that time may select one of the characters as the main protagonist to be role played by the user. In particular, the user interacts with the simulation by controlling the actions and response of the main protagonist to situations created and presented by the scenes in the simulation. As indicated, the main protagonist may be selected by the user. The user may also select the other characters to appear in the simulation to resemble the personality types of those the user works with. Alternatively, the main protagonist may be automatically selected by the software platform and its software to most closely represent the user's personality based on the self-assessment or on certain default criteria if an assessment is not used. The software may select the additional characters as well. Alternatively, the main protagonist and/or other characters may be selected by the user's manager, human resources specialist or other individual or outside consultant associated with the organization.

The scenes formed from the frames create an interactive scenario for the main protagonist requiring selection between various courses of action. At each point in the simulation, the displayed scene and its associated sound file effectively portray a situation which the user may encounter at their job during the performance of his/her responsibilities with the organization. These scenes, possibly involving multiple characters in successive frames or in a single frame, culminate in a decision point in which the main protagonist is required to choose between one of several courses of action for moving forward under the simulation. The user may select the course of action for the main protagonist which may or may not result in the desired or best outcome for the organization.

For example, FIGS. 13 through 22 illustrate a series of successive frames (each of which may alternatively be part of a larger scene). The frames together present the main protagonist with a situation where he/she is asked to take on two new department members who he learns are feuding with each other. In FIG. 13, foreground assets 132 are called up from storage and presented in the frame representing characters in the simulation. One of the characters, “JB,” is the main protagonist in this embodiment. In the frames shown in FIGS. 13 and 14, an audio clip is provided in the voice of JB. As shown in FIG. 16, the learning object 132 need not be that of a character, but can be another stored graphic, in this example, that of a computer screen presenting a simulated email to JB in which he is asked to welcome his two new team members. FIG. 17 shows a frame which is accompanied by an audio clip of the two characters arguing with each other. All of the dialogue may or may not appear in the text box 138.

In FIG. 20, the main protagonist is then presented with a learning object screen containing four options, or scenarios, on how best to proceed, from which scenarios the user must choose one. The user may choose:
1) not accept the new team members;
2) investigate the situation further;
3) accept the new members, but assign them to non-critical tasks; or
4) try and resolve the feud.

These different courses of action are presented as text options on the display, one of which may be selected by the user using the mouse driven pointer. Each text option may have a check box next to it for indicating selection of the associated option. Alternatively, each text option may be set up as a selectable hyperlink.

The selection of the proper course of action in the illustrated and other embodiments is based on objective criteria. These criteria may include: applicable state and federal law which dictate the appropriate action to be taken by the organization personnel in response to the situation presented by the simulation; organization guidelines and regulations provided in employee manuals which dictate the appropriate action to be taken by organization employees in response to the situation presented by the simulation; and the knowledge skill and experience of other organization employees or outside consultants who are familiar with the scenario presented by the simulation and understand the likely consequences of pursuing the various courses of action presented to the user as options for moving forward.

In embodiments of the invention, there may be one objective correct answer. In alternative embodiments, instead of there being one correct answer and the remaining, incorrect answers, the answers may be objectively weighted from best to worst. More than one answer may be correct in that both courses of action result in beneficial outcomes to the organization, but one results in a better outcome than the other. Similarly, one wrong answer may be worse than another wrong answer in that both courses of action result in outcomes detrimental to the organization, but one results in more dire consequences for the organization than the other. It's during the negative outcomes that the user is primed for the retention of data shared in interventions of MetaMentors and peer mentors (SMEs).

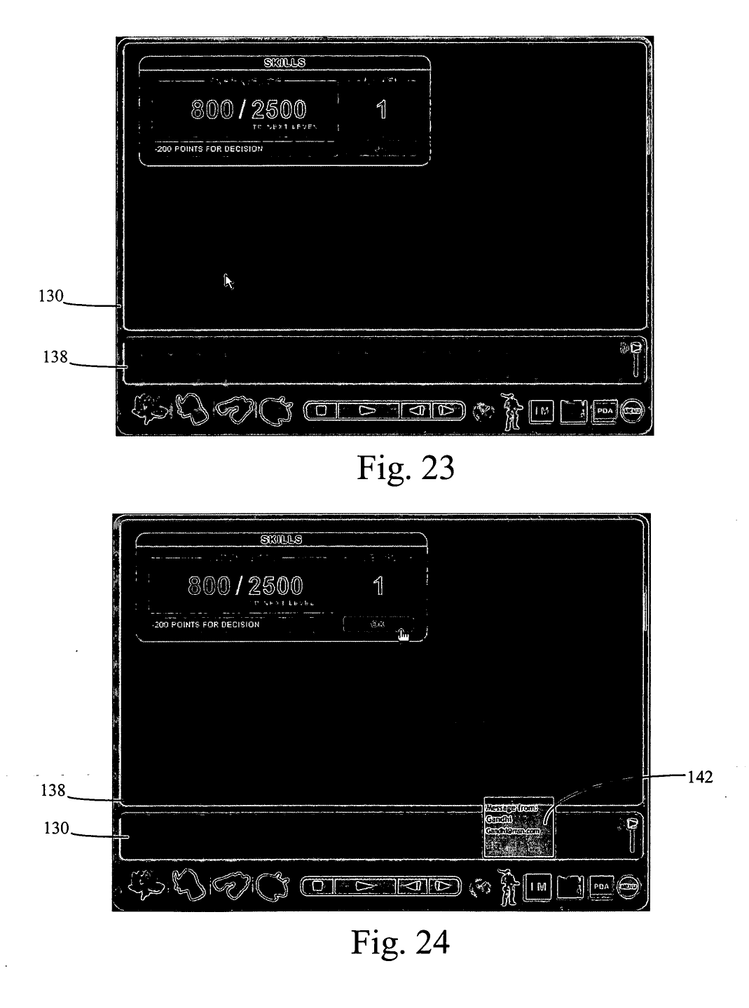

A running score may be kept by the software platform and its software to objectively measure a user's performance under the simulated scenarios. The score may be periodically presented to the user, as shown in FIGS. 23 and 24, to provide real time feedback on the user's performance under the platform and its software. A correct answer in response to a given set of possible options for moving forward would add to a user's overall score. An incorrect answer in response to a given set of possible options for moving forward would detract from a user's overall score. In embodiments where answers are objectively weighted, more than one answer may add to the user's score, with the better answer adding more points to the user's score. Similarly, in this embodiment, one incorrect answer may detract more points from the user's score than another incorrect answer, depending on the likely consequences of the respective wrong answers. Feedback screens that summarize the merits and faults of user selections are also employed at the conclusion of scenarios.

Each option presented to the user, when selected, has a different software operation associated with it. If the correct option is selected, the software causes one or more frames to be assembled from stored assets and played as one or more scenes showing the positive outcome of the selected option. The scenes may act out the consequences of the selection. For example, in response to a correct answer, the scenes may show a successful and timely completion of an important project and praise from the main protagonist's supervisor. Additionally, upon a correct choice, a predetermined number of points may be added to the user's running score and the score displayed to the user at this time.

The software platform and its software may then branch to a new situation set up by new scenes. In embodiments of the invention, the decision point of the new situation may present a more difficult solution than the earlier situation. The resolution to successive situations may become successively more difficult to resolve.

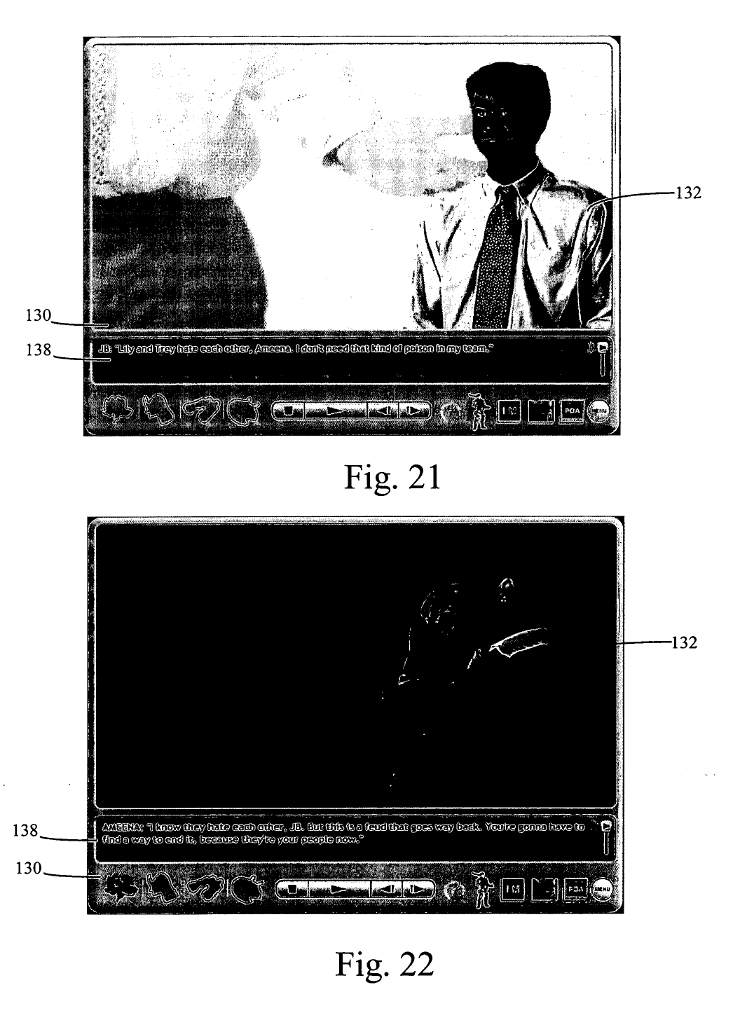

If an incorrect option is selected, as in the example set forth in FIGS. 13 through 22, the software causes one or more frames to be assembled and played as one or more scenes showing the negative outcome of the selected option. For example, as shown in FIGS. 21 and 22, in response to an incorrect answer, one or more scenes may be played. The scenes may act out the user's decision through the main protagonist. The scenes may also show that the main protagonist's supervisor is angry, and the main protagonist in the simulation may be reprimanded, or worse. Additionally, a predetermined number of points may be subtracted from the user's running score as shown in FIG. 23.

Upon an incorrect answer, the software according to the present invention may loop to one or more mentoring routines. In this way, a user receives real time feedback and information for a situation that the user has a real context for, having just gone through that situation and handled it incorrectly.

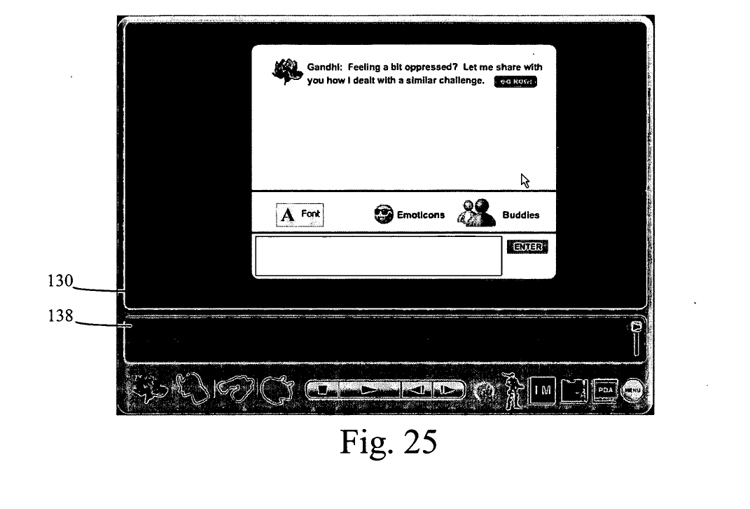

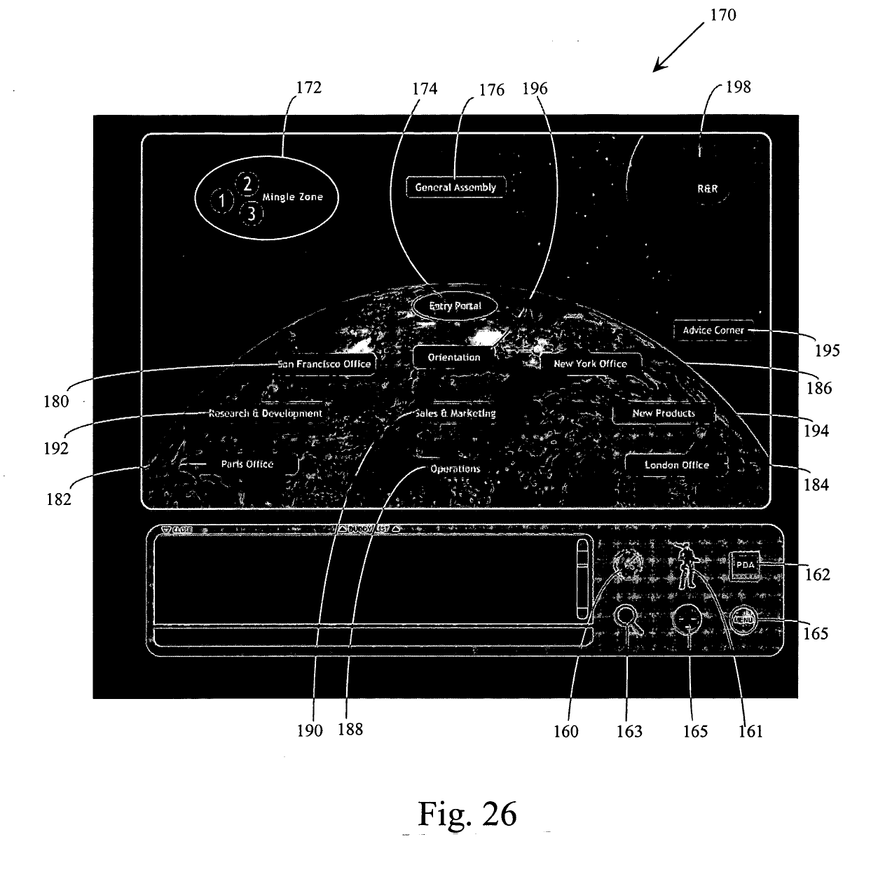

One of the ways the software according to the present invention provides feedback is to receive an instant message that a MetaMentor is trying to contact the user, as shown in FIGS. 24 and 25 and explained in greater detail hereinafter. Another way feedback is provided is to manually (through the user interface) or automatically loop to the second tier of the software for peer mentoring, as explained hereinafter.

After the MetaMentor and/or peer mentoring, the software platform and its software may then loop back to the simulation and branch to a new situation set up by scenes. Alternatively, the user is given the option to repeat the previous scenario.

MetaMentors

At any time during the simulation, the user may seek advice and assistance from a MetaMentor by calling a MetaMentor routine. Additionally, the software may automatically prompt the user to call a MetaMentor routine, through appearance of an instant message box on the graphical display, upon selection of an improper answer. The instant message box would be a stored multimedia file 142 in FIG. 24 which may say, for example, “Message from Gandhi” followed by a mock email address for Gandhi. The mock instant message when viewed may request that the user receive mentoring from the MetaMentor, as shown in FIG. 25, by executing a MetaMentor routine for mentoring by the software through the MetaMentor.

The MetaMentors used in the simulation are selected for certain desirable skills and/or character traits they are or were known to possess. For example, Gandhi for his non-combative dispute resolution capabilities; Genghis Khan for his strategic planning; Jane Goodall for her powers of observation; and Albert Einstein for his persistence, intelligence and wisdom. Certain situations with the main protagonist are known to require certain skills and/or character traits for proper resolution. If MetaMentoririg is required due to an incorrect response, the MetaMentor selected may be one whose skills and/or character traits most closely match those required for the resolution of the situation facing the main protagonist.

Upon calling a MetaMentor routine, the display changes from the scenes discussed above to stored multimedia files which display an introductory sequence portraying images of the MetaMentor and his or her historical significance, together with associated sound files. The MetaMentor routine then presents another multimedia file showing still photographs and/or animations, together with an associated narrative done in the voice of the MetaMentor,(meaning actual voice or actor's impersonating voice), presenting the user with a historical or fictitious situation, culminating in a decision point in which the user is required to choose between one of several courses of action that will result in the best outcome under the MetaMentor routine simulation.

For example, the MetaMentor may be Genghis Khan. An introductory display and narrative about him may be followed by a narrative from one supposed to be Genghis Khan with screen displays setting up a situation where the user will need to make a decision. For example, the user may be told he/she is one of Khan's sons, competing with Khan's other sons in military campaigns. You are told that you need to acquire furs for a winter campaign from a village that makes the furs. The user is then presented with different options for proceeding, for example, the following:
1) Slay the villagers and take the furs;
2) Negotiate a long-term agreement with the villagers to buy furs from them;
3) Collaborate with your brothers instead of competing with them.

Each option presented to the user, when selected, has a different software operation associated with it. If the correct option is selected, the software causes one or more multimedia graphics and sound files to be called which show the positive outcome of the selected option. Additionally, a predetermined number of points may be added to the user's running score and the score displayed to the user at this time. The user may also be provided with a MetaMentor gift which may be used to gain information during the simulation.

In particular, upon return to the organization simulation, a received MetaMentor gift appears on the graphical user interface. At certain predefined periods during the simulation, a user is able to select a received gift using the mouse pointer. If accessed at the appropriate time, selecting a received gift on the graphical user interface will cause one or more multimedia files of screen displays and/or sound files to be played which reveal additional information to the main protagonist regarding the situation he/she is facing. Covering a received gift on the graphical user interface with the mouse pointer may cause the gift to be highlighted and/or a sound file to be played, such as for example a glow or a bell sound. These special effects may also provide prompts for the user to activate the powers of the gift.

A MetaMentor gift may be a lotus flower from Gandhi which enables the user to hear what cannot be heard before in particular scenes, a helmet from Genghis Khan which empowers the user to be able to mind read, hearing the inner thoughts of characters shown over the display, or a pair of binoculars from Jane Goodall which provide the user with the ability to see things in scenes which were previously invisible. The gifts give more life to the MetaMentors and provide a bond between the MetaMentor and user during the simulation to improve the overall experience of the simulation.

Alternatively, if the incorrect option is selected, the software causes one or more multimedia graphics files and/or sound files to be called which show the negative outcome of the selected option. Additionally, a predetermined number of points may be subtracted from the user's running score. The user may then be given the option to repeat the MetaMentor simulation. The incorrect option is removed and the player is left to choose from other remaining options.

After the MetaMentor routine is completed, the platform and its software may then return to the simulation and branch to a new situation set up by new scenes. Generally, a summary screen of key points covered in the preceding sequence appears with voice over, text and images of illustrative key moments. In embodiments of the invention, these may be prefaced as “Keys to Success” white text on black background and feature signature sound effects. Alternatively, the user is given the option to repeat a previous scenario.

The user “walks in the footsteps” of the MetaMentor through the representation of historic circumstances or likely scenarios of the MetaMentor's life. The user is presented with a scenario and confronted with the same or similar choices faced by the MetaMentor. By selecting the correct option, through trial and error if the correct answer is not initially selected, the user is rewarded by the gift of a useful, symbolic treasure that is thereafter shown on the user interface (described in greater detail hereinafter).

The MetaMentor scenarios involve similar aspects of the dilemmas/challenges presented in the simulation which map to those the user confronts on the job or in life and which can be revealed through an assessment in the beginning of the simulation.

In a further embodiment of the present invention, the modern-day simulation (i.e., typified in FIGS. 13-22) may include hidden objects that symbolize creations of the MetaMentors. These hidden objects, referred to herein as MetaMentor inventions, may be paintings created by a MetaMentor painter, a book written by a MetaMentor writer, a musical score composed by a MetaMentor musician, etc. These objects may be under threat of capture by certain characters in the modern day simulation that may symbolically represent the “inner demons” of the MetaMentor creator (i.e., fear, indifference, imbalance, avarice, defeat, etc.). As a user successfully navigates through the simulation these “inner demons” may be symbolically exorcised by making these hidden objects visible and available to the user. In particular, if a user makes an optimal selection at a decision point, a scenario unfolds containing a scene in which one or more MetaMentor inventions, may be revealed to the user at which point, the user may acquire the MetaMentor invention.

These acquired MetaMentor objects become available to the user much like the gifts mentioned above and described hereinafter. The MetaMentor objects and gifts represent two distinct reward systems. The objects symbolize successful navigation and completion of the simulation, the liberation of the MetaMentor's inventions and the final eradication of the MetaMentor's inner demons. As such, the objects appear on the interface and lend themselves to the manufacture of physical replicas that can be provided as physical objects to users as a form of merchandise from the simulation realized as collectable souvenirs of the experience. The same can be true of the gifts and both can influence the look and feel of the zones within the adjoining Tier Two.

These MetaMentor objects may be represented in the software by stored hyperlinked images which only become accessible upon successful navigation of portions of the modern day simulation. When accessible and accessed by the mouse pointing device, these objects may be visible on the user interface.

The graphical user interface (GUI) 140 will now be described with reference again to FIG. 12. The text and graphics displayed on the computer screen as described above may be created with a variety of known mark up languages for creating web pages for presentation by a browser. Operations buttons 142 are provided for stopping, starting, rewinding and fast forwarding the graphics and text files as shown on the display screen. Peer Mentoring and Collaboration Link 144 is a hyperlink to the second tier peer mentoring and collaboration routines discussed hereinafter. Avatar Link 146 is a hyperlink to the Avatar routine discussed hereinafter.

Instant Messaging Link 148 is a link employed by the MetaMentors for communicating invitations, or employed by the user, to parallel lessons from the MetaMentors' lives that have been converted into non-linear simulations as described above. MetaMentor Overview Link 150 is a hyperlink which jumps to the MetaMentor routine discussed above. In embodiments of the invention, the MetaMentors' Overview Link 150 is provided in the appearance of an island, as in the island shown in FIGS. 10 and 11. This appearance symbolizes the infinite archipelago of MetaMentors and those few prescribed to meet the specific needs of a user. These chosen MetaMentors gather together and co-habit one of the islands for the duration of the simulation.

PDA Link 152 is a link to the user's personal contacts, email and calendar, which also operates in the embodiment of the invention as a navigational device enabling search-based learning, allowing users to select relevant scenes. Menu Link 154 provides access to software functions such as saving the current status of the simulation, quitting the simulation, options for altering appearance, sound and other options within the software program, and display of a graphics file having the credits for the authoring and production of the software program. The Menu Link 154 further provides access to the Instrumentals/Options screen showing specific components of the simulation such as Competencies, MetaMentors, Color Codes, as per Leadership Styles in one embodiment of the invention, depictions of characters by personality types, as in Prototypes, duration of the simulation, etc.

MetaMentor Gift Links 156 shows what gifts have been received from MetaMentors as described above. If a gift has been received, it will appear in the corresponding space provided for the gift (one such gift 158 is shown). As explained above, at certain times during the simulation a user may access a received MetaMentor gift with the mouse pointer, at which time additional information about a simulated situation is provided to the user. If a gift has not been received yet and its corresponding space is empty, accessing it with the mouse pointer will have no effect.

While the graphical user interface generally refers to the panel below the text box 138, it is understood that the term graphical user interface may also be used herein to refer to the entire display screen, on which hyperlinks may also be provided in the space where the assets 132, 134 are provided and that it may include further elements than those described and may not include all of those herein described.

At the close of the simulation, the user may be presented with screens providing a final assessment. The final assessment is provided to test the skills learned in the simulation. This may be in the form of new scenes presenting the user with another fact pattern and which culminate in a new learning object asking the user to choose between various scenarios. The scenes and learning object may be analogous to those described above and shown in FIGS. 13 through 22. However, the fact pattern, some or all of the characters, the learning object and scenarios may all be different from that shown in FIGS. 13 through 22, using different assets to form the frames, to present the user with a new test of his/her learned skill set from the simulation. Some or all of the content of the fact pattern, the scenes, the learning object and the scenarios may be dictated by the user's self-assessment and/or areas within the simulation where the user needed improvement. Once the user selects a given scenario, the user is then shown the consequences, positive or negative of his/her selection.

In embodiments of the invention, after the final assessment, the user may be provided with analysis and hyperlinks to resources that further address their learning needs, as well as being given the choice to engage in a further interactive exploration with some or all of the MetaMentors who accompanied the user through the simulation. Guided by selections made by the user via hyperlinks and/or drop down menus, the further interactive exploration may take the form of additional stored stories, knowledge and/or adventures shared by the MetaMentors. These additional stored stories, knowledge and/or adventures may be provided to the user, based on his/her selections, through various multimedia files including graphics, photographs, audio clips, video clips and/or animation.

Tier Two—Peer Mentoring and Collaboration

At any point in the simulation, the user can jump to a peer mentoring routine by accessing the peer mentoring and collaboration link 144 on the graphical user interface 140. Peer mentoring routine 144 may also be called up automatically if the user has chosen an improper path in dealing with a simulation situation.

Information gained through the peer mentoring routine is much more likely to be understood and retained than the same information given outside of the simulation. The simulation gives the information a context. Receiving information outside of the simulation of the present invention is not nearly as meaningful or effective as receiving the information after being in a situation where the user needed the information but did not have it. In this context, the user is much more likely to remember the information and understand the context in which it is to be used and applied in the future.

Accessing the peer mentoring routine calls up a graphics file and presents it in a new, second tier graphical user interface 170 such as for example that shown on FIG. 26. This graphical user interface provides several options for receiving advice and mentoring from peers, consultants, experts in a particular field and informational resource databases bearing on the skills being tested and taught in the simulation. The advice and mentoring may be received through live, interactive conversation with the peers and professionals who are connected to the network. Alternatively, the advice and mentoring may be received from information that peers, consultants and experts in a field have downloaded to a database, or other relevant information stored on a database. The database may be owned and operated by the organization to whom the user belongs. Alternatively, the database may be an independent informational resource on the World Wide Web.

Examples of the advice and mentoring from peers, consultants, experts and databases include: real time chat and instant messaging with peers, professionals, consultants and experts. In this “virtual world,” Bots, embody the skill and experience of people within the organization that have been downloaded and stored, and informational resources. Each of these is explained below.

Real Time Chat and Instant Messaginq

The Tier Two graphical user interface includes one or more hyperlinked images to a real time chat room and/or instant messaging. In one embodiment, the hyperlinked images may be grouped in a mingle zone 172 as shown on the attached figure. The zone may have three separate hyperlinked images numbered 1 through 3 respectively. It is understood that more or less of such hyperlinked images may be provided in alternative embodiments. Upon accessing one of the hyperlinked images, the user is brought to a screen which provides access to chat rooms and/or instant messaging. Once at this screen, the user can send a message out into a chat room requesting information or assistance on a certain topic, for example how to deal with a situation they encountered in the simulation. Alternatively, the user can send an instant message to a particular person the user believes to have useful information. Assuming the person is connected to the network at the time of the message, the user can instantly and interactively gain information which will be useful in the simulation and in real life situations. These people with whom the user connects may be a friend of the user, a peer known to user, an outside consultant, an expert in the field, or someone that the user does not know.

Avatars

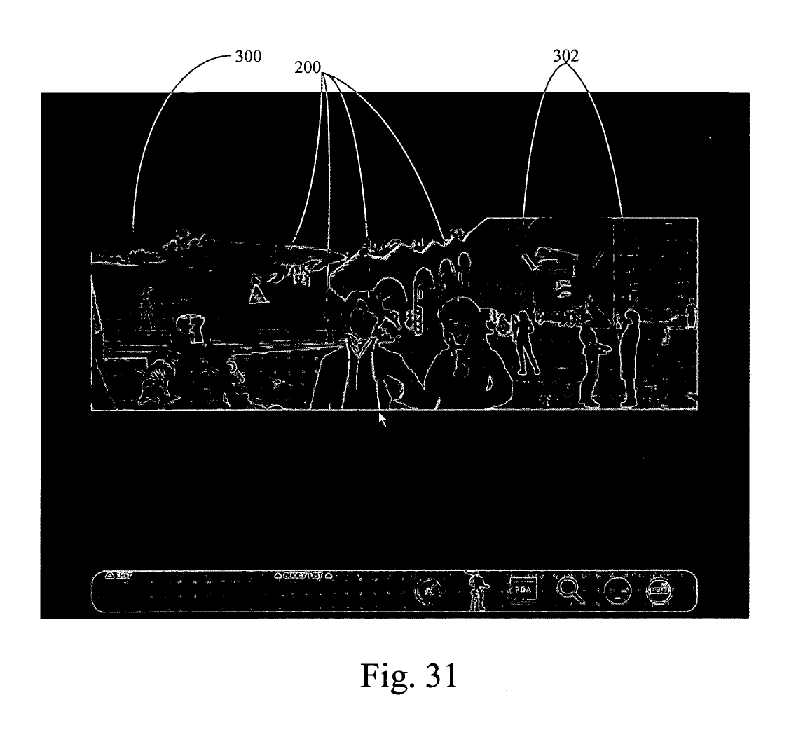

Avatars are virtual representations of the user, others who have gone through the simulation, and other people from within the organization. Avatars exist synchronously in real time in the Tier Two virtual world 300 shown in FIG. 31. That is, a person's Avatar may be found in the Tier Two virtual world 300 when that person is connected to the organization's network. The Tier Two virtual world is available to the user 24 hours a day, seven days a week.

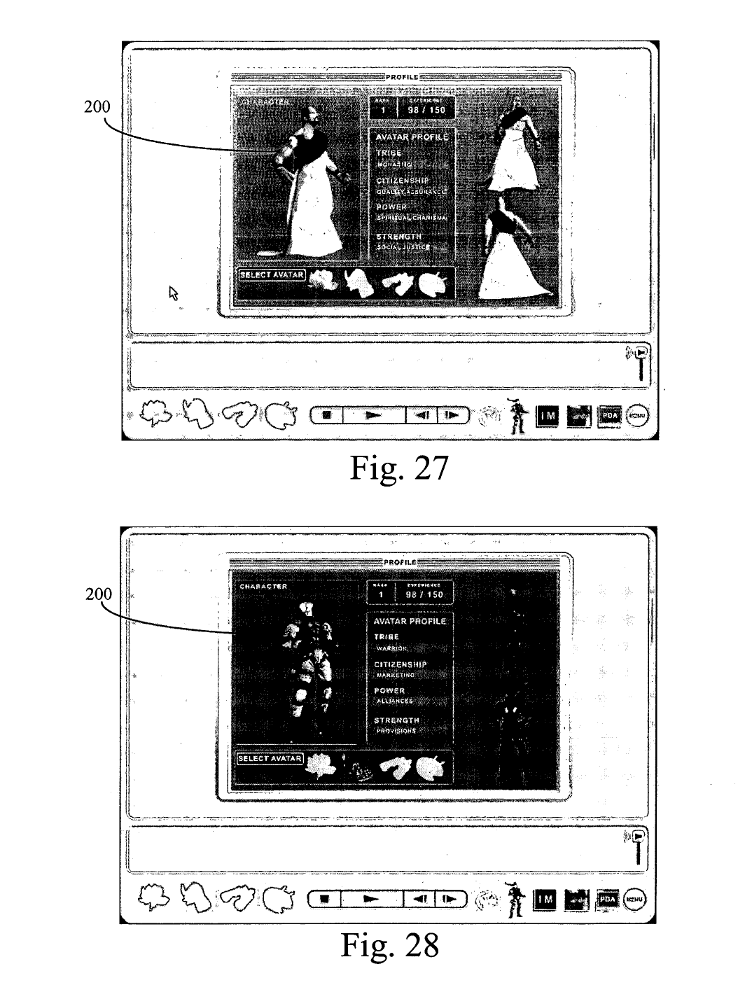

In one embodiment, to create an Avatar, the user is presented with a predefined list of Avatar archetypes to choose from. Each archetype has different character traits and strengths. The user is free to select the Avatar that he/she likes or identifies with the most. Alternatively, the user may be assigned to a particular archetype by virtue of their status within an organization or group. Examples of such Avatars are shown in FIGS. 27 through 30. Each of these screens is a stored graphics file including a description of the Avatar and a hyperlinked image with the text “select Avatar” for each of the different Avatar screens to allow the user to select a particular Avatar as his or her own. It is understood that more, less and/or other archetypes for Avatars may be used in alternative embodiments.

As the user progresses through the simulation, the user's Avatar takes on unique attributes which distinguish the user's Avatar from others. The unique attributes of the Avatar may be indicated by the appearance of the Avatar or a symbol associated with the Avatar. The attributes are gained based on the user's successes in the simulation and may include other traits, such as the position the user holds in the organization, geographical location and other classifications. These items become useful in the easy identification and location of potential members of communities of best practice in the virtual world, enabling geographically disperse populations to connect with each other. It also allows for organizations to quickly learn, on an immediate basis, where its strengths and weaknesses are in terms of trained, skilled people. This process is also a highly effective form of human capital management with built-in 24/7 recognition for individuals leading to improved performance and retention.

The virtual world 300 as shown in FIG. 31 may be accessed for example through the mingle zone 172 or the entry portal 174 (which is a hyperlinked graphic). Stored graphics, created in Photoshop and 3ds for example and presented for example with Macromedia Flash®, are used to depict the virtual world. At least some of the Avatars who exist in the virtual world are also separately stored graphics files with associated stored user data, character traits and experience. The virtual world may be set up to allow the user to “move around” in the world by moving the mouse pointer to different locations on the graphical user interface. For example, moving the mouse pointer to the right side of the portion of the virtual world shown in the graphic of FIG. 31 would cause the graphic to change and pan to the right. Moving the mouse cursor to the left would cause the portion of the virtual world shown to pan to the left. Navigation keys, either keys on the input device keyboard or virtual keys, may alternatively be provided. As indicated, the Avatars, the virtual world and “movement” around and within the world may be set up with stored multimedia files and known technology.

To add further entertainment value to the software movable Avatars may be viewed as more or less powerful, depending on factors such as the degree of information they possess, the type of information they possess, and/or the position within the organization of the person represented by the Avatar. In addition to gaining points for correctly navigating the simulation, the Avatars and virtual world add to the enjoyment of the simulation through role-playing and virtual rewards. An Avatar may become more powerful in the virtual world over time, by the person represented by the Avatar acquiring more knowledge and experience and/or by moving up in the organization. When this happens, an Avatar or its associated symbol may change accordingly to indicate the elevated status. Knowledge and experience may also be gained by an Avatar by successful navigation of the simulation by the person represented by the Avatar. An Avatar may also become more powerful in virtual world 300 independently of the simulation (for example as a result of a supervisor elevating the status of a person's Avatar within virtual world 300).

It is understood that the virtual world 300 as well as the appearance of the Avatars 200 within the virtual world 300 may vary significantly in alternative embodiments. For example, an Avatar may obtain finer and more elegant attire as he/she becomes more powerful through acquisition of knowledge, experience and position within the organization. Alternatively, an Avatar's physical attributes may be indicative of status. Other appearance characteristics are contemplated as an indicator of an Avatar's status and power.

Taking virtual world 300 and the Avatar paradigm a step further, in another embodiment, each Avatar could have various parts to its identity in the form of wardrobe, tools, weapons, magic spells, etc. and each of these would depict in some way the status and power of the Avatar. The power and status of an Avatar can be enhanced by the person gaining knowledge and experience, or performing well, in the company. This can result in the person's Avatar taking on a different appearance or by gaining additional possessions.

Downloaded Skill of People Within the Organization Bots

There are several advantages to downloading and saving the knowledge and experience of people within the organization, such as subject matter experts (SMEs). First, often the exact issues a person needs to deal with as part of his/her responsibilities have been dealt with before by others within the organization, and it would be a great benefit to be able to harness and tap into this experience base as a resource, without tying up the expert. With a Bot of an expert, they may need only to describe the data once for a very large number of people accessing it around the clock, around the world. Second, downloading an employee's experience and giving some identity to the downloaded material that may be directly or indirectly linked to the employee in effect immortalizes the employee for others to see. This is an effective way of rewarding the employee for their good work for the organization. Also, they will be less likely to leave the organization to go to another place where they have no such accolades.

The organization can have its SMEs and other experienced employees categorize and save their experiences, and how best to deal with particular situations, onto data files which are made available to others on the network. This information is saved in files referred to herein as Bots. A Bot may be a static representation of an SME or other skilled organization personnel whose expertise is available to friends and colleagues 24 hours a day, seven days a week. In addition to static information of SMEs and other skilled organization personnel, Bots may store other knowledge and experience, from within or outside of the organization, that is valued by the organization. The information stored as a Bot may be in any of various formats including: text, video, audio, graphics and/or flash. A Bot may present information in web pages, including content presented in any of various formats, such as drop down menus and/or hyperlinked images.

Bots may be tagged so that upon selection of an improper course of action, one or more Bots relevant to the user's situation are automatically presented to the user. For example, the user may receive an instant message, as described above with respect to FIGS. 24 and 25, from a Bot.

Alternatively, a user may search for a Bot in the Tier Two virtual world 300. In embodiments of the invention, a Bot may appear in the virtual world 300 with a similar appearance to an Avatar, but have a distinguishing symbol, such as for example shown at 302 in FIG. 31. A user seeking knowledge in virtual world 300 may navigate through the world until they find an Avatar 200 or Bot that has the degree and type of information they are looking for. A second way of finding an Avatar or Bot with the information sought by the user is through an index, which may be provided on a screen which may be accessed by the user from a link in the virtual world 300 or from the graphical user interface 170. The index may have several filters for finding an Avatar or a Bot. The filters can be broken down into various categories, including knowledge area, degree of knowledge and/or the location of the Avatar or Bot. The index may have a link which takes the user to the Avatar or Bot sought in the virtual world 300, or the index may describe where to find the Avatar or Bot in the virtual world 300. In embodiments of the invention, the index may be provided in a “general assembly” hyperlink 176 on user interface 170 (FIG. 26). The hyperlink 176 brings the user to a graphics file of a general assembly meeting place or hall, including index hyperlinks which direct the user to a particular Avatar.

Once the virtual world is accessed from the graphical user interface 170 shown in FIG. 26, a user may “move around” within the virtual world to find Avatars or Bots with information which the user is seeking. The desired Bot or Avatar may be located at least two ways. First, the Avatars and Bots in the virtual world may have an associated symbol. A symbol key may be provided to the user (visible through a screen which may be linked to from the virtual world 300 or from the graphical user interface 170) which provides the meaning of the symbols for Avatars and the symbols 302 for the Bots. For example, the symbols may be color coded, with certain colors identifying the type and degree of knowledge and experience that a Bot possesses. Alternatively, the symbols may have different appearances to signify the degree of knowledge and/or the type of knowledge.

The type of knowledge may refer to the fact that some Bots may be experienced in, e.g., sales, while others may be experienced in, e.g., management. There are many other areas of knowledge that a Bot may possess. Thus, each symbol may uniquely signify an area of knowledge and experience, as well as the degree of knowledge and experience in that area. It is contemplated that more than one symbol may be associated with a Bot to convey the Bot's area and degree of knowledge (for example, the more knowledge a Bot possess, the more associated symbols 302 it has). More than one symbol may additionally or alternatively be associated with a Bot to convey that the Bot has knowledge in more than one area.

Similarly, Avatars, representing the real-time presence of persons in the virtual world (versus the static bots), may also have a code-based appearance in which accoutrements carry significance such as the stars and bars on the uniforms of military officers. As described earlier, the proficiencies of a person can be readily conveyed by their Avatar, such as for example the position the person represented by the Avatar holds in the organization and the geographical location of the person. The symbol may additionally or alternatively convey what simulations according to the present invention the person has completed, what hobbies, interests and degrees the person has. The Avatar's outfit may convey whatever the individual or organization opts for or sees as important pieces of individual identifiers in the community. It is understood that Avatars may have symbols to identify the characteristics of the person represented by the Avatar. These symbols may be the same or different than the symbols 302 discussed above with respect to the Bots. Avatar

Once a Bot with the desired information is located, the Bot and/or its associated symbol may be a hyperlink to one or more screens and/or drop down menus giving information about the person represented by the Bot as well as conveying the knowledge and experiences of the person represented by the Bot. The information about the person may be the position of the person in the organization and the location of the person (to the extent not already provided by the symbol 302), as well as a history and/or resume of the person. The knowledge and experiences of the person may be conveyed in stories and/or multimedia files about specific situations and advice the person offers. Additionally or alternatively, the person's Bot may recommend additional informational resources, such as web sites, manuals and/or regulations.

Downloaded Skill of People Within the Organization—Emoticons

In a concept related to the Avatars, the stored knowledge and experiences of skilled employees may also be made available to the user through emoticons. These may be shapes, characters or other symbols which identify a source of knowledge and can give an indication of the type and degree of knowledge, as well as other information, in the same way that symbols 302 discussed above convey the source, type and degree of knowledge, as well as other information.

The emoticons are scaled down, simple graphical shapes that function as low-cost Avatars. A person's name in a chat room followed by various geometric symbols that mean different things - would be an example of emoticon usage.

An emoticon may appear as the identifier in any chat room or instant message the user participates in. As described above for symbols 302, when a user in a chat room or in instant messaging sees an emoticon, he/she can identify the person represented by that emoticon as possessing certain knowledge and experience that may be of interest to and beneficial to the user.

Informational Resources

In addition to the above-described sources of information for a user seeking assistance, the peer mentoring routine may also automatically call up information stored on an organization database or from the Internet in general, which is relevant to the course of action chosen by the user in the simulation. The organization may store information such as guidelines, applicable state and federal regulations and other information. This information may be indexed and automatically updated per inputs of organization personnel on the database, so that when a user makes an improper decision during the simulation, the user can be taken to the relevant guidelines, applicable state and federal regulations or other information which would have allowed the user to make the correct decision. When shown the relevant information in this context, the user is much more likely to remember the information and apply it correctly in the future. This information that becomes an intervention in the simulation is stored in data repositories and may be accessed by automation by choices made in simulations in which the learner is transported to the information source, a Bot, in the virtual world or the information automatically appears on the screen during the simulation, while containing a hyperlink to the bot for more information.

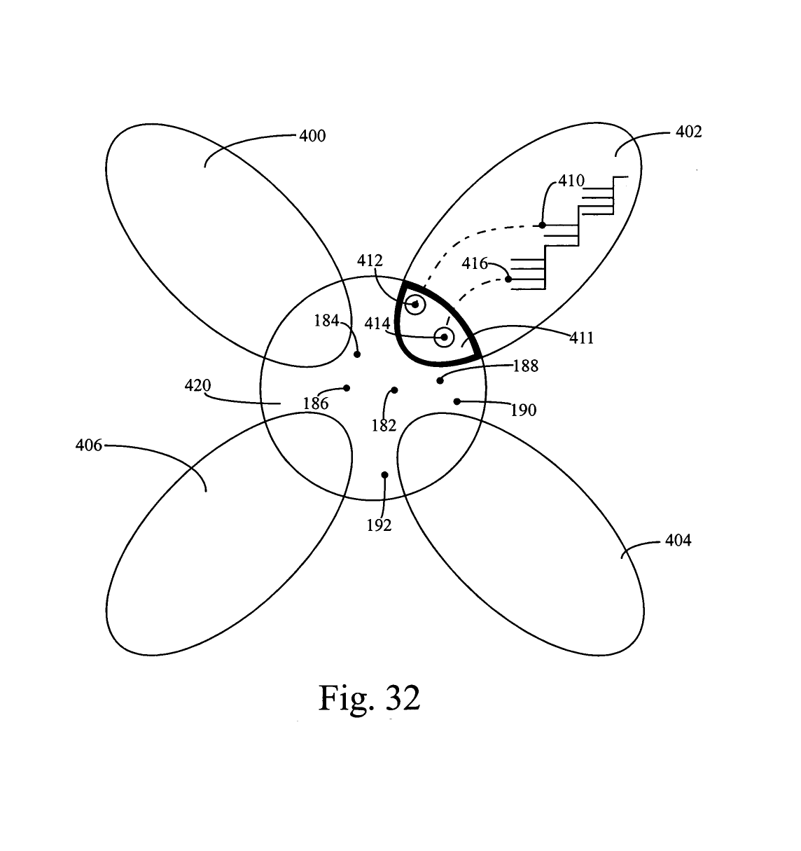

The user may also be given access to a search engine, such as for example Google, which allows the user to research the desired information from the World Wide Web, company intranet and individuals. Alternatively, that information may be pre-determined, selected and stored in various Bots located in the zone relating to the simulation as in 412 in FIG. 32.

The software according to the present invention allows for 24/7 peer mentoring by the methods described above. The chat rooms and instant messaging allow the user to speak with a live person to obtain mentoring and feedback any time there are others connected to the network and anywhere in the world. Similarly, the Bots, Avatars, emoticons and informational resources may also be accessed 24/7.

Tier Two—Collaboration

The software according to the present invention further allows 24/7 collaboration via the graphical user interface 170 in FIG. 26. This collaboration may be performed by the user of the simulation, applying the knowledge, skills and experience gained through the simulation to enhance his/her collaborative efforts. The collaboration aspects of the present invention may be used by an individual who has not gone through the simulation described above. That individual is also referred to hereinafter as a “user.”

The interface 170 includes hyperlinks to access a number of different collaboration portals, which provide access to different areas within the company. Through these portals, a user can access information in files on servers in one or more areas of the company; access contacts and employees from one or more areas of the company; perform instant messaging and chat with contacts and employees at these company locations; attend scheduled Webinars and access relevant World Wide Web data.

The data areas accessed by the collaboration portals may be from different geographic locations of the company, such as for example the Paris collaboration portal 180, San Francisco collaboration portal 182, London collaboration portal 184 and New York collaboration portal 186. The hyperlinks may access information on the servers in these geographic locations. Alternatively, the hyperlinks may access information on a server located elsewhere, for example in the corporate headquarters, that includes information relating to the branch offices.

Alternatively or additionally, the areas accessed by the collaboration portals may be from different organization divisions, such as for example the Operations collaboration portal 188, Sales and Marketing collaboration portal 190 and Research and Development collaboration portal 192. Again, the hyperlinks may access information on the servers in these corporate divisions. Alternatively, the hyperlinks may access information on a server located elsewhere, for example in the corporate headquarters, that includes information relating to the corporate divisions.

Once a particular hyperlink is accessed, in addition to accessing information from or relating to the different company locations, a graphics file may be called up illustrating either the particular company location, or an identifiable picture from the city of the company location. These include menus that describe the nature of the data, the file type and in some cases, access codes. Namely, if a user clicks on one of the portals, a series of menu items describing the nature of the file to be shared pops up. The access codes allow people to enter in their code for security clearance access, if necessary. These portals also feature Bots and present scheduled events featuring speakers and announcements.

The above described collaboration portals 180 through 192 allow the user to collaborate with colleagues within the different areas of the company and to gain information from the different areas of the company. The information within these portals may be presented to users of a simulation, as the data shared in them is delivered through Bots as well as real-time chat. Using the collaboration portals, a user may collaborate with different colleagues from the company on any number of different projects. For example, the user may deliver a presentation or introduce a new product. The Tier Two graphical user interface may include a new product link 194 which may call up a graphics file of a new product. These graphics files may also be used in connection with a presentation on the new product. The people with whom the user is collaborating may use a browser and appropriate logon credentials to see the information. The user may collaborate on other projects, such as persuading a work force to adopt a new approach or business strategy; gaining a better understanding of the company culture and vision for the future; and uncovering the best business practices for dealing with customers and business partners.

The platform and its software according to the present invention may incorporate known video conferencing protocols to allow scheduled meetings to collaborate on the above topics and for that data to be stored, indexed and accessible at later times. The collaboration portals may further allow sharing and viewing of contact information and files between colleagues.

The graphical user interface 170 includes additional portals in embodiments of the present invention. Advice hyperlink 195 may be accessed by the user in using Bots and seeking informational resources as described above. Orientation hyperlink 196 brings the user to a stored graphic of an organizational flow chart to help the user and others understand who is where in the organization. R&R hyperlink 198 calls a graphics file of a tranquil, restful place. It symbolizes a place where the user can go to relax. As with other destinations, here you can access a buddy list and invite them to join you for real time conversation.

The second tier graphical user interface 170 further hyperlinked graphics to assist in the navigation of the tier two peer mentoring and collaboration routine. A hyperlinked return graphic 160 is provided to return to the tier one simulation. A hyperlinked Avatar graphic 161 is provided to access the Avatar archetypes for selection of an Avatar as described above. A PDA Link 162 is a link to the user's personal contacts, email and calendar. A search hyperlink 163 provides a pop-up menu allowing the user to search for files on the network 102. A lobby hyperlink 164 returns to the graphical user interface 170 shown in FIG. 26 from other screens in tier two. And a menu hyperlink 165 provides access to software functions such as saving the current status of the simulation, quitting the simulation, options for altering appearance, sound and other options within the software program, and display of a graphics file having the credits for the authoring and production of the software program. The menu hyperlink 165 further provides access to the Instrumentals/Options screen showing specific components of the simulation such as competencies, MetaMentors, Leadership Styles, depictions of characters by personality types, duration of the simulation, etc.

FIG. 32 represents a high level view of the functionality of the software according to the present invention. As illustrated, the simulation discussed above may be one of several different simulations, running on different computer systems, which all tie into a single network. The different simulations may be drawn up to test and develop the same or different skills. For example, there may be a management simulation 400, a sales simulation 402, a competition simulation 404 and a research and development simulation 406. FIG. 32 further illustrates the portal connectivity of each of the simulations to the tier two—peer mentoring and collaboration functions.

During a simulation, a user is presented with various options and the user makes various choices based on those options. The options and decisions form a decision tree for navigating through the simulation. Where a user makes a choice that can have adverse consequences, the platform and its software can initiate a jump to the peer mentoring and collaboration portal, where the user can receive real time feedback and assistance as to the proper course of action by any of the means described above.

For example, if the user makes a poor decision at a point 410 in the simulation, the simulation can jump to the peer mentoring and collaboration portal where the user may tap into a community of best practices 411 (enclosed within thicker-lined region). The community of best practices 411 is a 24/7 virtual area where experts and interested people may congregate and participate in the zone's threaded chat and become recognized for contributions to the community. For example, upon a poor choice at a point 410 in the simulation, the user may find an informational resource 412 in community 411, such as for example a synchronous Avatar, a synchronous emoticon or an asynchronous Bot. The user may move back and forth between the simulation and the community of best practice as he/she progresses through the simulation. For example, after returning to the simulation from the point 410, the user may again select a course of action at a later point 416 in the simulation which again has adverse consequences for the organization. In this case, the user may again be returned to the community of best practice 411 to obtain a new informational resource 418.

There could be a separate community for best practice for each competency taught in the respective simulations. In organizations with many thousands to millions of internal Web pages, the grouping together of relevant data as it relates to simulations in 24/7 communities 411 in the organization's virtual world has great value for it enables members of the organization to quickly access relevant data and for that data's importance to be enhanced through contexts provided by simulations that prime users for key data interventions, leveraging information that would otherwise be ignored and so cause potential legal liability or lost market share, to name but two outcomes.

The communities of best practices are each part of the 24/7 Tier Two virtual world 420. In addition to access to synchronous Avatars and emoticons, and asynchronous Bots, the user can use the Tier Two virtual world 420 to access the various locations and perform various collaborative functions with others in the organization and outside the organization. This may be done via the various portals discussed above—the Paris collaboration portal 180, San Francisco collaboration portal 182, London collaboration portal 184 New York collaboration portal 186, Operations collaboration portal 188, Sales and Marketing collaboration portal 190 and Research and Development collaboration portal 192.

Although the invention has been described in detail herein, it should be understood that the invention is not limited to the embodiments herein disclosed. Various changes, substitutions and modifications may be made thereto by those skilled in the art without departing from the spirit or scope of the invention as described and defined by the appended claims.

1. An e-learning system allowing a user of the system to obtain mentoring and to collaborate with others over a computer system, the e-learning system comprising:
a simulation presented to the user over the computer system, the simulation including a plurality of characters, the user role-playing one of the characters;
a mentoring opportunity in which the user is capable of receiving mentoring over the computer system based on the user's actions in the simulation; and
a collaboration opportunity in which the user is capable of collaborating with others over the computer system.

2. An e-learning system as recited in claim 1, wherein the simulation provides the user with a learning object from which the user selects a scenario from among at least two scenarios, the selection of the scenario having a positive or negative outcome for the role-played character in the simulation.

3. An e-learning system as recited in claim 1, wherein the mentoring the user is capable of receiving in the mentoring opportunity is from a MetaMentor over the computer system.

4. An e-learning system as recited in claim 1, wherein the mentoring the user is capable of receiving in the mentoring opportunity is a synchronous event.

5. An e-learning system as recited in claim 4, wherein the synchronous event is an on-line chat or instant message with at least one other person in real time.

6. An e-learning system as recited in claim 5, wherein the at least one other person is represented by an Avatar on the computer system.

7. An e-learning system as recited in claim 5, wherein the at least one other person is represented by an emoticon on the computer system.

8. An e-learning system as recited in claim 1, wherein the mentoring the user is capable of receiving in the mentoring opportunity is an asynchronous event.

9. An e-learning system as recited in claim 8, wherein the asynchronous event is a stored informational resource.

10. An e-learning system as recited in claim 8, wherein the informational resource is a Bot.

11. An e-learning system allowing a user of the system to obtain mentoring over a computer system, the e-learning system comprising:
a simulation presented to the user over the computer system, the simulation including a plurality of characters, the user role-playing one of the characters; and
a mentoring opportunity in which the user is capable of receiving mentoring over the computer system based on the user's actions in the simulation, the mentoring coming at least in part from a MetaMentor, the MetaMentor being stored information presented to the user over the computer system representing a famous person, the MetaMentor further having associated stored knowledge, experience and information from the person represented by the MetaMentor.

12. An e-learning system as recited in claim 11, the MetaMentor mentoring the user upon the user performing an action resulting in a poor result for the role-played character.

13. An e-learning system as recited in claim 11, the MetaMentor mentoring the user upon the user performing an action resulting in a positive result for the role-played character.

14. An e-learning system as recited in claim 11, the MetaMentor mentoring the user upon the user performing an action resulting in a neutral result for the role-played character.

15. An e-learning system as recited in claim 11, further comprising hidden objects representing inventions of the MetaMentors.

16. An e-learning system as recited in claim 11, further comprising unobtainable objects representing inventions of the MetaMentors which may become obtainable upon the user making an optimal selection at a decision point in the simulation.

17. An e-learning system as recited in claim 16, wherein physical replicas of the objects may be provided as merchandise from the simulation realized as collectable souvenirs of the experience.

18. An e-learning system allowing a user of the system to obtain mentoring over a computer system, the e-learning system comprising:
a self-assessment in which the user is accessed through a series of questions presented to the user;
a simulation presented to the user over the computer system, the simulation including a plurality of characters, the user role-playing one of the characters; and
a mentoring opportunity in which the user is capable of receiving mentoring over the computer system based on the user's actions in the simulation, the mentoring coming at least in part from stored information;
the simulation, the characters and/or the stored information that is presented to the user being at least in part dictated by the self-assessment or an assessment of some kind submitted on behalf of the user.

19. An e-learning system as recited in claim 18, the simulation including one or more scenes which include one or more frames which include one or more assets.

20. An e-learning system as recited in claim 19, wherein at least one of the one or more scenes, one or more frames and one or more assets shown to the user are dictated by the self-assessment or an assessment of some kind submitted on behalf of the user.

21. An e-learning system allowing a user of the system to obtain mentoring and to collaborate with others over a computer system and a network of which the computer system is part, the e-learning system comprising:
a simulation presented to the user over the computer system, the simulation including a plurality of characters, the user role-playing one of the characters; and
a mentoring and collaboration portal through which the user may access knowledge available from other sources over the network bearing on the user's actions in the simulation.

22. An e-learning system as recited in claim 21, wherein the mentoring and collaboration portal allows the user to access knowledge in a synchronous event.

23. An e-learning system as recited in claim 22, wherein the synchronous event is an on-line chat or instant message with at least one other person in real time.

24. An e-learning system as recited in claim 23, Wherein the at least one other person is represented by an Avatar on the computer system.

25. An e-learning system as recited in claim 23, wherein at least one other person is represented by an emoticon on the computer system.

26. An e-learning system as recited in claim 21, wherein the mentoring and collaboration portal allows the user to access knowledge in an asynchronous event.

27. An e-learning system as recited in claim 26, wherein the asynchronous event is a stored informational resource.

28. An e-learning system as recited in claim 27, wherein the informational resource is a Bot.

29. An e-learning system as recited in claim 21, wherein the mentoring and collaboration portal further allows the user to share information with at least one other source over the network.

30. An e-learning system as recited in claim 29, wherein the at least one other source comprises a different geographical location of an organization to which the user belongs.

31. An e-learning system as recited in claim 29, wherein the at least one other source comprises a different organizational department in an organization to which the user belongs.

32. An e-learning system as recited in claim 21, wherein information shared by the user via the mentoring and collaboration portal comprises at least one of a presentation, product information, persuading a work force to adopt a new approach or business strategy, gaining a better understanding of the company culture and vision for the future, and uncovering best business practices for dealing with customers and business partners.
